(19) United States
(12) Patent Application Publication
(10) Pub. No.: US 2013/0189702 A1
(43) Pub. Date: Jul. 25, 2013

(54) Curve Processor Algorithm for the Quality Control of (RT-) qPCR Curves

(71) Applicants: Gabriela Altmann, Berlin (DE); Mareike Dartmann, Koln (DE); Inke Sabine Feder, Leverkusen (DE); Tanja Ropers, Moers (DE); Claudia Roth, Kerpen (DE); Karsten Weber, Leverkusen (DE)

(72) Inventors: Gabriela Altmann, Berlin (DE); Mareike Dartmann, Koln (DE); Inke Sabine Feder, Leverkusen (DE); Tanja Ropers, Moers (DE); Claudia Roth, Kerpen (DE); Karsten Weber, Leverkusen (DE)

(73) Assignee: Siemens Healthcare Diagnostics Inc., Tarrytown, NY (US)

(21) Appl. No.: 13/642,358

(22) PCT Filed: Apr. 7, 2011
(86) PCT No.: PCT/EP2011/055406

§ 371 Date: Mar. 29, 2013

(30) Foreign Application Priority Data
Apr. 21, 2010 (EP) 10160573.1

(51) Int. Cl. G06F 19/10

(52) U.S. Cl. CPC G06F 19/10
USPC 435/6.12; 702/19

(57) ABSTRACT

The invention is in the field of analytical technology and relates to an improved procedure for determining the concentration or activity of an analyte in a sample. Specifically the invention provides an automated algorithm for the quality control of (RT-)qPCR reactions. Plotting the fluorescence intensity of a reporter dye divided by the fluorescence intensity of a passive reference dye against the cycle number leads to a so-called sigmoid function which is characterized by a background phase, an exponential growth phase and a plateau phase. Since the fluorescence intensity as a function of cycles relates to the initial number of template molecules in the sample, qPCR curves can be used to quantify the amount of RNA or DNA fragments in the sample by determination of a so-called Cq value.

### 1. FIELD OF THE INVENTION

The invention is in the field of analytical technology and relates to an improved procedure for determining the concentration or activity of an analyte in a sample. Specifically the invention provides an automated algorithm for the quality control of quantitative PCR (qPCR) assays.

### 1.1. Polymerase Chain Reaction (PCR)

The Polymerase Chain Reaction (PCR), developed in 1984 by Kary Mullis, is a means to amplify the amount of DNA or mRNA fragments, e.g. of a specific gene, in a (patient) sample. If mRNA fragments shall be amplified, they first have to be transcribed to cDNA in a reverse transcription (RT) step. In this case, the reaction is called RT-PCR.

The PCR takes place in small reaction tubes in a thermal cycler. The reaction mix consists of
the original DNA template which contains the region (target) that should be amplified
two primers which tag the beginning of the region that should be amplified on the sense respectively anti-sense strand of the DNA
the (Taq) polymerase which synthesizes new DNA strands
deoxynucleoside triphosphates (dNTPs) which are the components of the DNA strands to be synthesized
a buffer solution
divalent magnesium or manganese cations and monovalent potassium cations.

### 1.1.1. Basic Amplifying Procedure

The PCR process is a sequence of ˜20-50 cycles, each of them consisting of the following three steps:
1. Denaturation: The reaction mix is heated to a temperature of 94-96° C. for 20-30 seconds. In the first cycle, this step can take up to 15 minutes (Initialization). The purpose of these high temperatures is to annihilate the hydrogen bonds between the two strands of the double-stranded DNA.
2. Primer annealing: The temperature is lowered for ca. 30 seconds to a temperature which is specific for the annealing of the primers to the single-stranded DNA (˜50-65° C.). Too high temperatures lead to excessive thermal movement; hence the primers can't bind to the DNA. Temperatures which are too low forward unspecific binding of the primers to sequences of the DNA which are not entirely complementary.
3. Extension/Elongation: The temperature is increased again to a temperature at which the (Taq) polymerase works best (˜70-80° C.). The polymerase uses the dNTPs to synthesize new DNA strands which are complementary to those strands which are tagged by the primers. It starts at the 3′-end of the primer. If everything works fine, the target DNA in the reaction mix is duplicated in each cycle.

If the number of target molecules in the reaction mix at the beginning of the reaction is c₀, the number of target molecules after n cycles is

cₙ=c₀·(1+E)ⁿ (1)

or equivalently

log_{(1+E)}(cₙ)=n+log_{(1+E)}(c₀) (2)

where E denotes the efficiency of the PCR reaction.

Ideally the DNA is duplicated in each cycle, and the efficiency equals one. Plotting log_{(1+E)}(cₙ) against the cycle number, one would theoretically get a straight line with slope one and intercept log_{(1+E)}(c₀). Two different values of c₀ would lead to parallel straight lines, the one belonging to the higher value of c₀ lying above the one belonging to the lower value of c₀. This is not correct in reality, because at the beginning and at the end of the PCR the process is inhibited for different reasons. During the first cycles there is just a small amount of template molecules, therefore the portion of the fluorescence signal which is caused by the template molecules is negligible. The end of the reaction is characterized by decreasing reactant concentrations and thus the reaction rate saturates; another problem that can occur is the deterioration of reactants.

The PCR can also be used to quantify the amount of DNA or mRNA fragments in a sample. In this case, a real-time Polymerase Chain Reaction (qPCR) has to be carried out which relies on the basic PCR. It takes place in a TaqMan (Applied Biosystems) or MX3005 (Stratagene), for example.

### 1.1.2. Basic Quantifying Principle

The qPCR follows the same pattern as the basic PCR except that a probe has to be added to the reaction mix. This probe is labeled by two fluorophors, a reporter and a quencher, and has to be designed in such a way that it binds to the target DNA strands. This binding takes place during the primer annealing phase. If the probe is activated by a specific wave length during this phase, the fluorescence of the reporter is suppressed due to the spatial vicinity of reporter dye and quencher dye as the reporter releases its energy to the quencher. The underlying concept of this energy transfer is called FRET (fluorescence resonance energy transfer). During the elongation phase the polymerase eliminates the probe which is dissolved. Thus the distance between reporter dye and quencher dye increases and the reporter begins to fluoresce. The higher the number of templates, the higher the number of redundant reporter molecules, therefore the intensity of the fluorescence is a measure of the initial number of target molecules.

Plotting the fluorescence intensity after n cycles against the cycle number n leads to a so-called sigmoid function which consists of three different parts:
1. Background: The number of target molecules and therefore the fluorescence intensity is very small during the first cycles. The fluorescence appears to be constant in the beginning, because the intensity caused by the amplified template is dominated by the so-called background fluorescence. The background fluorescence might be caused by impurities and degenerated reactants in the well or the optical subsystem of the PCR machine.
2. Exponential growth: During this phase, the fluorescence can be well described by equation (2), where the initial fluorescence intensity is assumed to be proportional to c₀.
3. Plateau: Due to the consumption of available nucleotides and other limitations the synthesis of product slows down at some time. The intensity doesn't increase exponentially any more during the last cycles, but reaches a saturation phase.

To quantify the amount of DNA or mRNA fragments in a sample one now compares the fluorescence intensity to a pre-defined threshold and determines the cycle at which this threshold is reached for the first time (linear interpolation is used between subsequent cycles to obtain fractional cycle numbers). The (fractional) cycle at which the threshold is reached for the first time is called Cₜ value. The earlier this takes place the higher was the amount of initial target molecules in the reaction mix. It is important that the threshold is chosen in such a way that the Cₜ value is obtained during the exponential growth phase.

When using a TaqMan or a MX3005 to carry out the qPCR, the determination of the Cₜ values is done automatically by the associated software (SDS respectively MX Pro) except that the operator has to choose the threshold that shall be used when working with the TaqMan. If this threshold isn't reached until the end of the reaction, the Cₜ value is called “Undetermined” (SDS software language). Due to contaminations within the reaction mix, failures of the laser or the photo detector which measures the fluorescence intensity or other problems occurring during the reaction some qPCR curves show a behavior which deviates from the common sigmoid shape. These curves have to be filtered out by visual inspection of the operator, a process which is time-consuming and subjective.

The concept described in the second and third chapter of this document is a means to automate on the one hand the determination of C_{q} values and on the other hand the quality control of qPCR reactions carried out on any appropriate instrument. It has only been tested for reactions carried out on a TaqMan up to now. In this context, the term C_{q} value denotes—like the Cₜ value—a value which provides information about the initial amount of DNA or mRNA fragments in the sample and about the validity of a curve.

### 1.1.3. Summary of Literature/Prior Art

1) A Flexible Sigmoid Function of Determinate Growth
Xinyou Yin, Jan Goudriaan, Egbert A. Lantinga, Jan Vos, Huub J. Spiertz
Annals of Botany, 2003

The paper works on the determination of a function which is well suited to describe the sigmoid pattern of determinate growth in agricultural crops. A new function, the so-called “beta growth function” which is characterized by the three parameters tm, to and wmax, is proposed and its advantages (and disadvantages) in comparison to the logistic function, Richards' function, the Gompertz function, the Weibull function and two expolinear equations are worked out.

Difference to Our Invention:

No regularization was used to fit the model to the data.

No constraint like the linearityNorm was introduced to ensure robust fitting in case of zero target molecules.

No optimization of starting point for fitting routine is described.

No rules are proposed to decide if a curve really shows a sigmoid pattern or not.

Agricultural crops are investigated, not fluorescence data of qPCR reactions.

2) A new method for robust quantitative and qualitative analysis of real-time PCR
Eric B. Shain, John M. Clemens
Nucleic Acids Research, 2008

The paper presents a new method for the analysis of real-time PCR data, the so-called “maxRatio method”. This method contains the following steps:

### 1) Calculation of

$$ratio ( n ) = \frac{fluorescence ( n )}{fluorescence ( n - 1 )} - 1$$

for each cycle n.
2) Determination of the maximal value of the mapping ratio(n), this value is called MR.
3) Determination of the fractional cycle n for which ratio(n)=MR holds. This fractional cycle is called FCN.
4) Determination of the position of the point (FCN, MR) in a plot which depicts the MR value against the FCN value for a set of reference curves and thus classification into “normal reactive” (large MR, large FCN), “abnormal reactive” (medium MR, medium FCN) and “nonreactive” (small MR, small FCN).

Difference to Our Invention:

No model is fitted to the fluorescence data, therefore neither regularization nor constraints nor an optimization of the starting value is worked on.

3) A new real-time PCR method to overcome significant quantitative inaccuracy due to slight amplification inhibition
Michele Guescini, Davide Sisti, Marco B L Rocchi, Laura Stocchi, Vilberto Stocchi
BMC Bioinformatics, 2008

The paper compares four different methods (Ct method, second derivative (Cp) method, sigmoidal curve fitting (SCF) method, and Cy0 method) for the analysis of qPCR data. Of these, the Cy0 method (based on a nonlinear regression of Richards' equation) is the most accurate and precise method even in suboptimal amplification conditions.

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

4) Quantitative real-time RT-PCR based transcriptomics: Improvement of evaluation methods
Ales Tichopad
Dissertation, 2004
   Description of (RT-)qPCR reactions
   Model used to describe the data:
   1) four-parametric sigmoid function (without background increase, based on
      logistic function)
   2) four-parametric logistic model
   Quantification by second derivative maximum of four-parametric sigmoid function (CP=n0−1.317*b) or Ct method
   Description of experiments
   Investigation of optimal quantification range
   Exact determination of efficiency (fitting of exponentially behaving phase with exponential model: f=gamma0+alpha*epsilon̂n)
   Algorithm for analysis of (RT-)qPCR data (quantification without reference gene or standardised quantification with reference gene)

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

5) Determination of stable housekeeping genes, differentially regulated target genes and sample integrity: BestKeeper—Excel-based tool using pair-wise correlations
Michael W. Pfaffl, Ales Tichopad, Christian Prgomet, Tanja P. Neuvians
Biotechnology Letters, 2004

The paper presents a software called “BestKeeper” intended to enhance standardization of RNA quantification results (as, for example, results gained by an RT-PCR). The tool chooses the best suited standards out of ten candidates and combines them into an index (as geometric mean) whose correlation to the expression levels of target genes can be computed. Used are Cp (crossing point) values which are gained by the “second derivative maximum” method as computed by the LightCycler software or Ct values.

Difference to Our Invention:

No model is fitted to the fluorescence data, therefore neither regularization nor constraints nor an optimization of the starting value is worked on.

No rules are proposed to decide if a curve really shows a sigmoid pattern or not.

6) Inhibition of real-time RT-PCR quantification due to tissue-specific contaminants
Ales Tichopad, Andrea Didier, Michael W. Pfaffl
Molecular and cellular probes, 2004

The paper works on the influence of unknown tissue-specific factors on amplification kinetics. Various methods of Cp value acquisition (first derivative and second derivative maximum of the four-parameter sigmoid model, “fit point method” and “second derivative maximum method” computed by the LightCycler software, “Taqman threshold level” computation method) are analyzed for this purpose.

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

7) Standardized determination of real-time PCR efficiency from a single reaction set-up
Ales Tichopad, Michael Dilger, Gerhard Schwarz, Michael W. Pfaffl
Nucleic Acids Research, 2003

The paper works on a computing method for the estimation of real-time PCR amplification efficiency. Instead of using serial dilution steps the following procedure is applied:
Linear regression of first three observations→Is the last observation an outlier? No→Linear regression of first four observations and so on→Procedure is stopped when at least three subsequent observations are outliers→The first of these three observations is regarded as the endpoint of the background phase and starting point of the exponential growth phase
Determination of the endpoint of the exponential growth phase: Observation directly before the maximum of the second derivative (either as computed by the LightCycler software or from a four-parametric logistic model)
Estimation of efficiency: Fitting of an exponential model (f=y0+alpha*Ên) to the fluorescence data contained in the region of exponential growth

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

8) Tissue-specific expression pattern of bovine prion gene: quantification using real-time RT-PCR
Ales Tichopad, Michael W. Pfaffl, Andrea Didier
Molecular and cellular probes, 2003

The quantification of expression of bovine prion (proteinaceous infectious particle) in different organs via real-time RT-PCR is described and it is shown how the organs are involved in pathogenesis. Quantification is carried out via the “Second Derivative Maximum Method” as being implemented in the LightCycler software (second derivative maximum within exponential phase of amplification curve is linearly related to a starting concentration of the template DNA).

Difference to Our Invention:

No model is fitted to the fluorescence data, therefore neither regularization nor constraints nor an optimization of the starting value is worked on.

No rules are proposed to decide if a curve really shows a sigmoid pattern or not.

9) Improving quantitative real-time RT-PCR reproducibility by boosting primer-linked amplification efficiency
Ales Tichopad, Anamarija Dzidic, Michael W. Pfaffl
Biotechnology Letters, 2002

The paper works on the impact of primer selection on the performance of real-time PCR reactions. For this purpose, a four-parametric sigmoid model is fit to the fluorescence data. Via ANOVA it is shown that most of the variance between b (slope) parameters (which is a measure for the efficiency of the primer itself and the variance of amplification efficiency) results from the use of different primers, not different tissues. Defining Cp as the maximum of the second derivative of the used four-parametric sigmoid model leads to CP=n0−1.317*b. Since the CP value is linearly related to b, the variability in CP values is linearly related to the amplification efficiency. It is mentioned that other sigmoid models can be used, too.

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

10) Inhibition of Taq Polymerase and MMLV Reverse Transcriptase by Tea Polyphenols (+)-Catechin and (−)-Epigallocatechin-3-Gallate (EGCG)
Ales Tichopad, Jürgen Polster, Ladislav Pecen, Michael W. Pfaffl
Submitted, 2004

The effect of catechin and EGCG on the performance of (RT-) PCR reactions is investigated. This is done by fitting a mathematical model (the four-parametric sigmoid model) to the data and comparing the resulting fitting parameters for reactions with and without catechin and EGCG (ANOVA). Quantification is achieved by computing the maximum of the second derivative of the four-parametric sigmoid model or by using the “second derivative maximum method” implemented in the LightCycler software.

Difference to Our Invention:

No regularization was used to fit the model to the fluorescence data.

No constraint like the linearityNorm was introduced to ensure robust fitting in case of zero target molecules.

No optimization of starting point for fitting routine is described.

No rules are proposed to decide if a curve really shows a sigmoid pattern or not.

11) Genomic Health Patent (WO 2006/014509 A2)

Difference to Our Invention:

No Gompertz function is used to fit a model to the normalized fluorescence data of a qPCR curve. Instead, a linear regression analysis is performed in adjacent (possibly overlapping) regions of the data. A score relying on these regression data represents the quality of the well and determines its Pass/Fail status.

The computation of a quantification value does not rely on “overall estimated” parameters “inflexion point” and “slope”, but on a localized (for example quadratic) regression of the data in a predefined region and subsequent comparison with a threshold.

No description of
regularization
constraints
optimization of starting value

12) Automated Quality Control Method and System for Genetic Analysis
(U.S. Pat. No. 7,398,171 B2)

Difference to Our Invention:

Quality control metrics are used to determine the status of a well (e.g. empty well), but these metrics are not derived by fitting any models to the fluorescence data. The only exception is the derivation of the metric which tests if genetic material and probe dyes have been amplified. This metric fits a straight line to the amplification curve in order to get a baseline amplification curve.

13) WO 2010/025985

A linear regression is performed on the linear range of the fluorescence data of an RT-PCR reaction. Those values lying outside the linear range are compared to a threshold to determine if there is a signal at all. Afterwards, a (Gompertz) model is fitted to the background-subtracted data and rules relying on the fitting parameters are defined to classify a curve as valid or invalid. Quantification is achieved by using a cp value (maximum of second derivative) or a by value (intersection between background and tangent in the inflexion point).

Difference to Our Invention:

No regularization was used to fit the model to the fluorescence data.

No constraint like the linearityNorm was introduced to ensure robust fitting in case of zero target molecules.

No optimization of starting point for fitting routine is described.

The rules which are defined are only univariate, in our invention there are also bivariate rules.

### 2. DESCRIPTION OF THE INVENTION

The invention provides an automated algorithm for the quality control of (RT-) qPCR reactions. Plotting the fluorescence intensity of a reporter dye divided by the fluorescence intensity of a passive reference dye against the cycle number leads to a so-called sigmoid function which is characterized by a background phase, an exponential growth phase and a plateau phase. Since the fluorescence intensity as a function of cycles relates to the initial number of template molecules in the sample, qPCR curves can be used to quantify the amount of RNA or DNA fragments in the sample by determination of a so-called Cq value. Due to contaminations within the reaction mix, unintended chemical reactions within wells, failures of the optical system of the PCR device which measures the fluorescence intensity, or other problems occurring during the reaction (e.g. air bubbles) some qPCR curves show a behavior which deviates from the common sigmoid shape. Information gained by these curves shouldn't be used for further analyses. Therefore, quality control of qPCR curves consists of three steps:

1) Determination if a curve is valid at all.
2) Determination if the initial number of template molecules is zero or very small (below some LOD).
3) Determination of a Cq value which relates to the initial number of template molecules for all curves which are valid.

A mathematical model (on the basis of the Gompertz function which is suitable to describe sigmoid curves) is fit to the data in consideration of nonlinear constraints and regularization parameters. In detail, values for parameters y0, r, a b and n0 are chosen in such a manner that the deviation (normalized sum of squared errors) between the data and the model

$${f}_{gompertz} ( x ) = {y}_{0} + r \cdot x + a \cdot exp ( - exp ( - \frac{x - {n}_{0}}{b} ) )$$

is minimized, where x denotes the cycle and f(x) is fitted to the normalized fluorescence signal. Parameter b is forced to be positive (by considering exp(beta) instead of b) and a is regularized to be approximately 3.9110. Additionally, parameter combinations for which the largest absolute difference between the exponential term on the right hand side of the equation (called Gompertz term) and a straight line gained by a linear regression of the Gompertz term (called linearityNorm) is smaller than 10-3 are forbidden by a constraint. The parameters n0 and b are used for the definition of a so-called AIP value which is a measure of the amount of RNA fragments in the sample. The optimal AIP value was found to be

AIP=n₀−0.72·b

The six features (y0, r, a, b, n0, linearityNorm) and the AIP value are used to define a set of rules which identify a curve as “Numeric” (quantification by AIP value), “Invalid” (curve is not reliable and should be ignored for further processing) or “Undetected” (initial number of molecules zero or very small).

There are several inventive steps that have to be combined to yield the advantages:

We used regularization of parameter a to ensure robustness of the fitting of the Gompertz model.

We introduced the linearityNorm constraint to ensure robust fitting in case of zero target molecules.

We optimized the starting point and customized the numeric optimization algorithm to yield meaningful parameter values (intended local minimum of objective function).

Based on real data we defined rules that rely on the features y0, r, a, b, n0, linearityNorm, AIP and that classify fluorescence curves into “Numeric”, “Invalid” or “Undetected”.

The first advantage which arises from the present invention is the objectivity and reproducibility of the method. This is especially advantageous for curves for which the decision between “Numeric” and “Invalid” is questionable and differs when asking different operators. In addition, tests have shown that when analyzing triplicate measurements the number of outliers is smaller when using the curve processor algorithm instead of Ct values. Furthermore, Cq values do not depend on the choice of a certain threshold.

The second advantage is saving of work time which currently is necessary to manually control fluorescence curves. Thus, costs are reduced.

The invention relates to a method for determining the concentration or activity of an analyte in a sample, the method comprising:
a) mixing a sample with at least one reagent, whereby an analyte-dependent amplification reaction is set in motion, wherein the amplification of the analyte is detectable by a signal;
b) measuring a signal changing over time as a result of the analyte-dependent amplification reaction;
c) mathematically fitting a curve to signal measurements, wherein said mathematical fitting comprises of
   (i) the use of an extended Gompertz function, given by.

$${f}_{gompertz} ( x ) = {y}_{0} + r \cdot x + a \cdot exp ( - exp ( - \frac{x - {n}_{0}}{b} ) ) ,$$

where x denotes the time, f denotes the signal, and y0, r, a, n0 and b are parameters to be fitted,
(ii) regularization of at least one parameter or a mathematical combination of parameters such that signal curves not showing saturation within the observed time interval can be fitted robustly and with sufficient confidence,
(iii) and mathematically extracting a score value from said fitted curve;
d) performing a quality control of said signal-time curve and determining the concentration or activity of said analyte, comprising the steps of
   1) Determination if said signal-time curve is valid, wherein said signal-time curve is valid, if said score value can be extracted reliably,
   2) Determination if the initial number of template molecules is below a limit of detection (LOD), and
   3) Determination of the concentration, wherein the score value relates to the initial number of analyte molecules for all curves which are valid,
   wherein steps (1), (2), and (3) can be performed in any given order.

In this context, “extracting a score value reliably” refers to the ability to generate a similar score value in a duplicate experiment.

Said score value can be the above described Cq value.

When measuring a signal's changing over time, time can be measured as real time (in seconds, minutes or hours) or, in the case of cyclic amplification reactions such as PCR time can also be measured in terms of amplification cycles.

According to an aspect of the invention the analyte is a nucleic acid, in particular DNA or RNA, in particular mRNA.

According to an aspect of the invention the analyte-dependent amplification reaction is a PCR reaction, in particular a Reverse Transcriptase PCR (RT-PCR) reaction.

According to an aspect of the invention the amplification of the analyte is detectable by a fluorescence or optical signal.

According to an aspect of the invention an absolute concentration can be determined by use of an internal standard of known concentration.

According to an aspect of the invention said regularization is performed on parameter a. In particular, said regularization may be realized by a summand additional to the objective function used for fitting, where the summand is a weighted square of the z-transformed parameter a. Parameters of the z-transformation, i.e. mean and standard deviation, are empirical estimates from samples of signal curves showing saturation within the observed time interval which were known to be fitted robustly and with sufficient confidence.

According to an aspect of the invention parameters are constrained during fitting to ensure robust and confident estimation of parameters for curves showing no amplification behavior or amplification behavior in the very end only. Constraints may be uni- or multivariate, linear or non-linear. In particular, a constraint may be used comprising the following steps (linearityNorm):

(i) A linear model is fitted to the extended Gompertz model on the observed time interval. (Said extended Gompertz model is defined by some parameter set which may not be optimal.)
(ii) The deviation between the linear and the extended Gompertz model is calculated using some mathematical norm (e.g. Euclidian, Manhattan or max-Norm) and based on the observed time interval.
(iii) Said deviation is compared to a suitable threshold such that a parameter set of the extended Gompertz model is said to be allowed if said deviation is above said threshold and the parameter set is said to be forbidden if said deviation is below said threshold.

Alternatively, instead of the extended Gompertz model one can use the Gompertz core only, which is defined as

$${f}_{gompertzCore} ( x ) = exp ( - exp ( - \frac{x - {n}_{0}}{b} ) ) .$$

According to an aspect of the invention the fitting of the extended Gompertz model is realized by a gradient-based or local optimization algorithm and wherein the starting point for said optimization algorithm and its configuration is chosen such that the resulting local optimum corresponds to a fitted model, for which the technical interpretation of the curve corresponds to the meaning of the parameters: parameters y0 and r describe the beginning of the curve (background), parameters n0 and b describe the time point and velocity—respectively—of the amplification growth, and parameter a describes the height of the saturation level above background. In particular, parameters b and a must be positive.

According to an aspect of the invention the model fit is realized using a Euclidean distance measure, and wherein the optimization is nested by separating parameters: For fixed parameters b and n0 parameters y0, r, and a are optimized analytically by linear algebra operations since the objective function (including regularization) is a quadratic form of these parameters; and parameters b and n0 are optimized non-linearly in an outer loop. This approach is advantageous, because it needs fewer iterations, it is more robust, and starting values have to be defined only for parameters b and n0.

According to an aspect of the invention said quality control classification is realized by a decision tree, wherein each decision is based on at least one feature from the following list: said parameters (y0, r, a, b, n0), said score, a goodness-of-fit measure, the times of observation (in particular the bound of the interval) and features from constraints according to claims 8 or 9 if used. Each decision is derived from empirical training data by a data-driven method, wherein training curves are classified into said quality control classes by manual inspection, commercially available software or a combination of both.

According to an aspect of the invention said observed time interval may be restricted previous to described calculations in order to eliminate measurement outliers or parts of the curve showing behavior deviating from typical amplification behavior.

According to an aspect of the invention said decision tree is degenerated to the following linear list of rules:
Is firstCycle greater than or equal to 10? If yes, set classification to “Invalid”.
Does the absolute value of y0 exceed 20? If yes, set classification to “Invalid”.
Does the absolute value of r exceed 1? If yes, set classification to “Invalid”.
Is a greater than 25 or smaller than −15? If yes, set classification to “Invalid”.
Does b exceed 50? If yes, set classification to “Invalid”.
Is n0 greater than 65 or smaller than 15? If yes, set classification to “Invalid”.
Is the logarithm of linearityNorm smaller than or equal to −3.5? If yes, set classification to “Undetected”.
Is the logarithm of linearityNorm smaller than or equal to −1.5 and the logarithm of b greater than or equal to 2.2? If yes, set classification to “Undetected”.
Is score smaller than 34 and a smaller than or equal to 0.2? If yes, set classification to “Undetected”.
Is score smaller than 34 and a greater than 0.2 as well as smaller than 1? If yes, set classification to “Invalid”.
Is score greater than or equal to 34 and a smaller than or equal to 0.6? If yes, set classification to “Undetected”.
Is score greater than or equal to 40? If yes, set classification to “Undetected”.
Otherwise set classification to “Valid”.
   where
measurements have been undertaken at times x=1, 2, 3, 4, . . . (cycle numbers).
firstCycle is related to the number of the first cycle where the measured signal is not an outlier with respect to the fitted model.
linearityNorm is a measure of the linearity of the fitted model according to claim 9 using the max-Norm and the Gompertz core. The linearityNorm constraint is defined by comparing the logarithm of the linearityNorm with a threshold
the score is calculated as: score=n0−0.72b.

The invention further relates to an apparatus which is capable of automatically carrying out the method according to any of claims 1 to 14 for determining the activity or concentration of an analyte, comprising
a) means for the determination of the signal changing over time as a result of the analyte-dependent amplification reaction,
b) means for mathematically fitting a curve to signal measurements and mathematically extracting a score value from said fitted curve and storing a resultant score value, wherein said mathematical fitting comprises the use of a Gompertz function,
c) means for performing a quality control of said signal-time curve, and
d) means for determining a concentration or activity of the analyte according to said score value.

The invention further relates to a computer program product for carrying out the method according to the invention for determining the activity or concentration of an analyte, comprising:
i) means for mathematically fitting a curve to signal measurements and mathematically extracting a score value from said fitted curve and storing a resultant score value, wherein said mathematical fitting comprises the use of a Gompertz function,
ii) means for performing a quality control of said signal-time curve, and
iii) means for determining a concentration or activity of the analyte according to said score value.

### 2.1. Overview

In the following, the invention is described in exemplary fashion using the illustrative example of a quantitative RT-PCR (RT-qPCR) as amplification reaction. The method of invention may be applied to other amplification reactions yielding sigmoid growth curves.

The fluorescence data gained during an (RT-)qPCR reaction will be described and it will be explained how they are normalized in order to obtain so-called Rₙ values which will be used for further processing. Afterwards it will be illustrated how outliers are detected and eliminated from further analysis. The Gompertz function will be presented as an appropriate mathematical model to describe the curvature of the Rₙ values and it will be explained why concepts like regularization and the definition of constraints are necessary to achieve a good fit. It will be pointed out that there are many examples for curves which show an awkward behavior in the first cycles which leads to the necessity of leaving an appropriate number of cycles out during the optimization routine. Technical details of this routine will be explained afterwards and it will be emphasized how important the choice of a skilled starting value is to force the routine to end up in the right minimum. Afterwards it will be explained how the C_{q} value (score value) is defined and which rules are necessary to distinguish valid curves from curves with very low or zero target concentration and curves with an awkward behavior which can't be trusted and have to be sorted out for analysis.

### 2.2. Data Preprocessing

Reference is made to the attached Figures.

### 2.2.1. Description of the Data

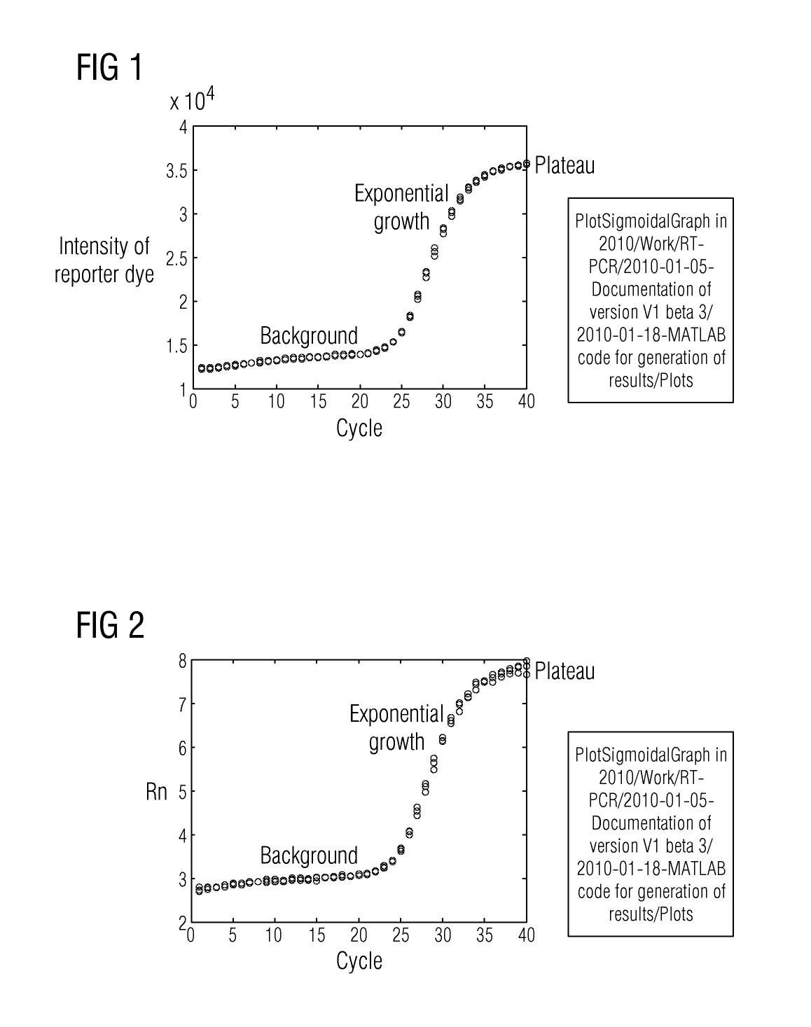

As described above, plotting the fluorescence data of a reporter dye gained during an (RT-) qPCR reaction against the cycle number leads to a so-called sigmoid graph characterized by three different phases: background, exponential growth and plateau, as shown in FIG. 1

FIG. 1: Fluorescence Intensity of Reporter Dye Vs. Cycle

### 2.2.2. Calculation of Rₙ Values

Normalizing these data by the fluorescence data of a passive reference dye which are almost constant hardly changes the shape of the graph, only the scale of the y-axis is altered. These normalized fluorescence data are called Rₙ, as shown in FIG. 2.

$${R}_{n} = \frac{fluorescence intensity of reporter dye}{fluorescence intensity of passive reference dye} \qquad ( 3 )$$

FIG. 2: Rₙ vs. Cycle

### 2.2.3. Outlier Elimination

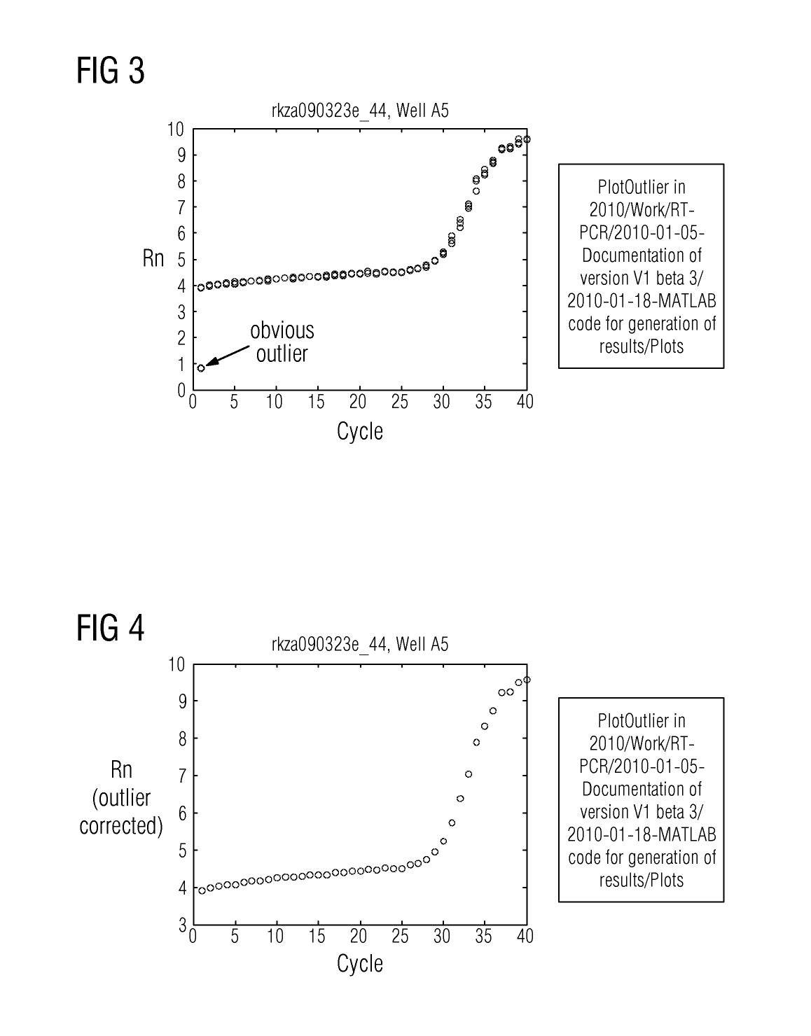

A question that arises is how to deal with repeated measurements of one cycle. Dependent on the instrument that is used during the reaction and on the settings chosen by the user the data arising from an experiment can differ in the number of cycles and the number of measurements per cycle. For example, when using the TaqMan and the SDS software, three (or more) measurements are recorded for each of the 40 cycles; other protocols define different measurements e.g. one measurement per cycle only for MX3005/MxPro™. In the case the repeated measurements are close together in each cycle (which means the difference between them can be explained by measurement noise only) one can just compute the mean of the three repeats (we use the SDS software language here) to obtain one Rₙ value per cycle. It also has to be defined what has to be done in the presence of one or more outlier(s) as shown in FIG. 3.

FIG. 3: Outlier in First Cycle

By computing the mean of the three measurements during the first cycle one would get an Rₙ value of approximately three for the first cycle which does not suit the remaining curve. Therefore it would be better to detect the measurement resulting in an Rₙ value of approximately one as outlier and leave it out of the analysis by computing the mean of the remaining two measurements during the first cycle. For this purpose, a method to detect outliers was established. This method consists of the following steps:
The mean of the repeated measurements per cycle is computed:

$$cycleMean ( i ) = \frac{{R}_{ni , 1} + {R}_{ni , 2} + {R}_{ni , 3}}{3} ,$$

where i denotes the number of the cycle and R_{ni,j} denotes the normalized fluorescence data of the j^{th} repeat of the i^{th} cycle (assuming there are three repeated measurements per cycle). The same method can be applied for any other number of repeats per cycle, of course.
The deviation of each repeat from the cycle mean is calculated:

res_{i,j}=R_{ni,j}−cycleMean(i).
The deviations are normalized according to the number of available repeats kᵢ per cycle:

$${res}_{i , j} = \sqrt{\frac{{k}_{i}}{{k}_{i} - 1}} \cdot {res}_{i , j} ,$$

where k is the number of repeats successfully measured and not yet identified as outlier in cycle i.
The total variance of all measurements in all cycles is computed:

$$variance = \frac{{\sum }_{i , j} {res}_{i , j}^{2}}{{\sum }_{i} {k}_{i} - 1} .$$

Those repeats for which the absolute normalized deviation from the cycle mean exceeds six times the total standard deviation are called outliers:

j^{th} repeat of i^{th} cycle outlier [symbol] |res_{i,j}|>6·\sqrt{variance}
As soon as the number of available repeats per cycle falls to one or zero, all repeats of this cycle are defined to be outliers, because an estimate of the true value becomes impossible.
This procedure is carried out as long as no more outliers are found.

Coding missing repeat measurements as well as detected outliers as NaN (not a number) simplifies an implementation.

Applying this method to the data shown in FIG. 3 and computing the mean of each cycle afterwards leads to the following Rₙ curve shown in FIG. 4.

FIG. 4: Data of FIG. 3 after Outlier Elimination and Averaging

There are three objectives that can now be defined:
1. Find a continuous model function characterized by preferably few parameters which describes the given data in a meaningful way.
2. Find a robust fitting procedure which determines for each given set of fluorescence data the best choice of parameters.
3. Define a C_{q} value which provides information about
   the validity of a fluorescence curve
   the amount of DNA or mRNA in the sample.

### 2.3. Calculation of Parameters

### 2.3.1. The Gompertz Function

Many different sigmoid functions can be found in literature (e.g. logistic function, Gaussian error function, Gompertz function, . . . ) and one can't decide ad hoc which of them is the most appropriate means to describe the fluorescence data of (RT-)qPCR reactions. In detail, the aforementioned functions are of the form

$$\begin{matrix}{f}_{log} ( x ) = \frac{1}{1 + exp ( - b \cdot ( x - {n}_{0} ) )} \\ ( logistic function , also called Richards function ) & ( 4 ) \\ {f}_{gauss} ( x ) = \frac{1}{\sqrt{π \cdot b}} \cdot {\int }_{- ∞}^{x} exp ( - \frac{{( t - {n}_{0} )}^{2}}{b} ) d t \\ ( Gaussian error function ) & ( 5 ) \\ {f}_{gompertz} ( x ) = exp ( - exp ( - \frac{x - {n}_{0}}{b} ) ) \\ ( Gompertz function ) . & ( 6 )\end{matrix}$$

As can be seen immediately, all of these functions consist of two parameters b and n₀ which are necessary to describe the inflexion point and the sigmoid shape of the curve. Furthermore, a detailed analysis shows that logistic function and Gaussian error function are symmetric around their inflexion point and all three functions fulfill the conditions

$$\begin{matrix}{lim}_{x \to ∞} f ( x ) = 1 \\ and & ( 7 ) \\ {lim}_{x \to - ∞} f ( x ) = 0 & ( 8 )\end{matrix}$$

if b is greater than zero. Since fluorescence data of (RT-)qPCR reactions have a background that is different from zero and a plateau height which differs from one, the use of any of the three functions requires a transformation of the form

y₀+r·x+a·ƒ(x) (9)

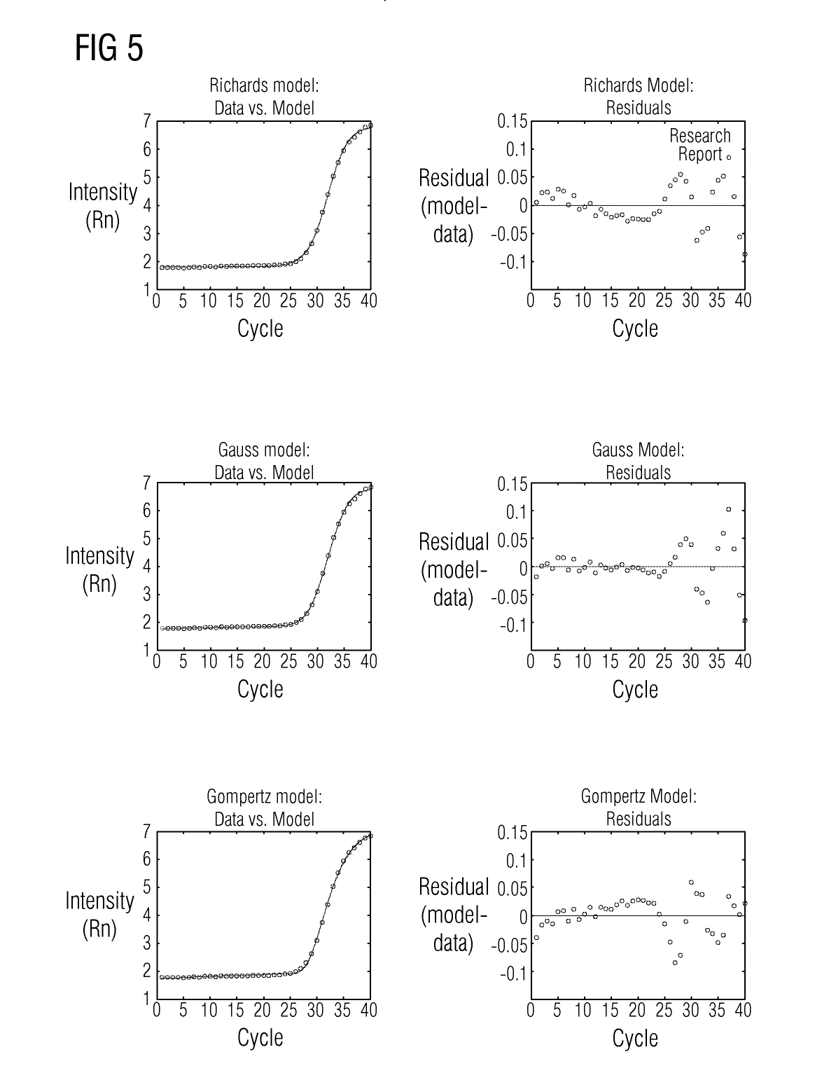

with additional parameters y₀, r, and a. Up to this stage of analysis all three functions seem comparably suited to describe the fluorescence data, because all of them are of sigmoid shape, need the same number of parameters (namely five) and show the appropriate convergence behavior. As mentioned before the Gompertz function shows no symmetry, indeed, but this is no disadvantage because the fluorescence data don't indicate the need of symmetry. In order to find out which function to use, all of them were fitted to a set of example data and the residuals of the fits, i.e. the deviations between models and data, were examined. The results can be seen in FIG. 5. While all fits are good in the background phase, the residuals of the Gompertz model are smaller than the residuals of the other two models in the plateau phase, where Logistic function and Gaussian error function underestimate the data. Furthermore, logistic function and Gaussian error function seem to have a problem with the curvature of the data between the exponential growth and the plateau phase, see FIG. 5.

FIG. 5: Candidate Models Vs. Experimental Data

Thus, we chose the Gompertz function to describe the Rₙ values of (RT-)qPCR reactions:

$$Rn ( x ) \approx f ( x ) = {y}_{0} + r \cdot x + a \cdot exp ( - exp ( - \frac{x - {n}_{0}}{b} ) ) . \qquad ( 10 )$$

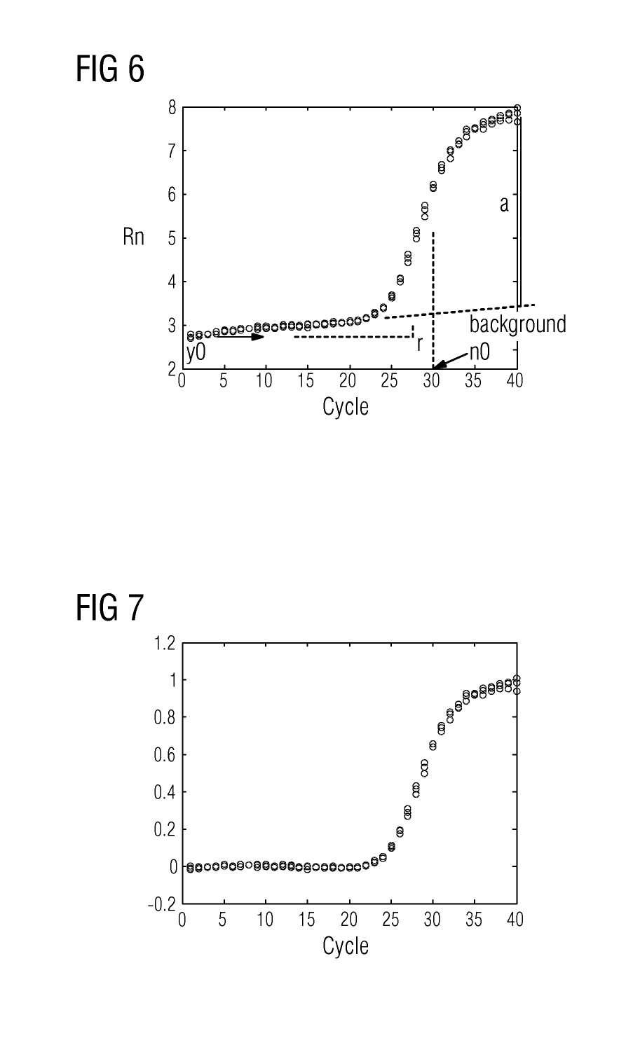

The meaning of the five parameters which characterize the Gompertz function can be described quite easily by geometric means, see FIG. 6:
The “background intercept” y₀ and the “background slope” r both characterize the background phase of the fluorescence data. In detail, y₀ is a measure for the background level and r indicates to what extent the background increases during the reaction.
The “pedestal height” a estimates the height of the plateau over the background.
The parameter n₀ is the inflexion point of the curve.
The “sigmoid width” b is a measure for the length of the sigmoid region.

FIG. 6: Geometrical Interpretation of Parameters (Except b)

To explain the geometrical relevance of the sigmoid width b, some more considerations have to be made. Firstₐ of all, subtracting the background in equation (10) and dividing by the pedestal height leads to the term

$$exp ( - exp ( - \frac{x - {n}_{0}}{b} ) ) \qquad ( 11 )$$

on the right-hand side of the equation. This term is bounded by zero from below and by one from above, still being of sigmoid shape, see FIG. 7.

FIG. 7: Rₙ (Background-Subtracted and Normalized by Pedestal Height) Vs. Cycle

The next step is to determine those fractional cycles x_{low} and x_{high} which define the beginning and the end of the exponential growth phase, respectively. This can be done by resolving the equations

$$\begin{matrix}0.001 = exp ( - exp ( - \frac{{x}_{low} - {n}_{0}}{b} ) ) \\ and & ( 12 ) \\ 0.999 = exp ( - exp ( - \frac{{x}_{high} - {n}_{0}}{b} ) ) . & ( 13 )\end{matrix}$$

Showing the solution for x_{low} exemplary, one gets

$$\begin{matrix}log ( 0.001 ) = - exp ( - \frac{{x}_{low} - {n}_{0}}{b} ) \\ and & ( 14 ) \\ log ( - log ( 0.001 ) ) = - \frac{{x}_{low} - {n}_{0}}{b} & ( 15 )\end{matrix}$$

by taking the natural logarithm twice and thus

x_{low}=n₀−log(−log(0.001))·b (16)

Similarly, one gets

x_{high}=n₀−log(−log(0.999))·b (17)

Taking equations (16) and (17) together, one realizes that the width of the exponential growth phase is

x_{high}−x_{low}=(−log(−log(0.999))+log(−log(0.001)))·b=8.8399·b (18)

explaining why b is called “sigmoid width”. Since the length of the exponential growth phase should be positive, it is advisable to replace b by exp(β) and optimize β instead of b. Equation (10) is therefore replaced by

$${R}_{n} ( x ) \approx f ( x ) = {y}_{0} + r \cdot x + a \cdot exp ( - exp ( - \frac{x - {n}_{0}}{exp ( β )} ) ) . \qquad ( 19 )$$

The objective of the fitting routine is thus the solution of the minimization problem

$$\begin{matrix}{min}_{c} {‖ f ( x , c ) - {R}_{n} ( x ) ‖}^{2} \\ with & ( 20 ) \\ c = ( {y}_{0} r a β {n}_{0} ) . & ( 21 )\end{matrix}$$

### 2.3.2. Regularization

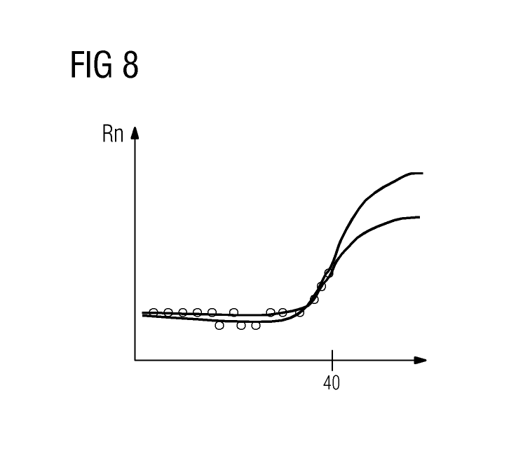

Some more considerations have to be made on the pedestal height a: Given fluorescence data of experiments with low target concentrations where the plateau phase is not reached within the range of observed cycles the three parameters characterizing the exponential growth and the plateau phase are not well determined by the data and the resulting fit lacks of robustness. This situation is shown exemplarily in FIG. 8.

FIG. 8: Illustration of Uncertainty in Fit

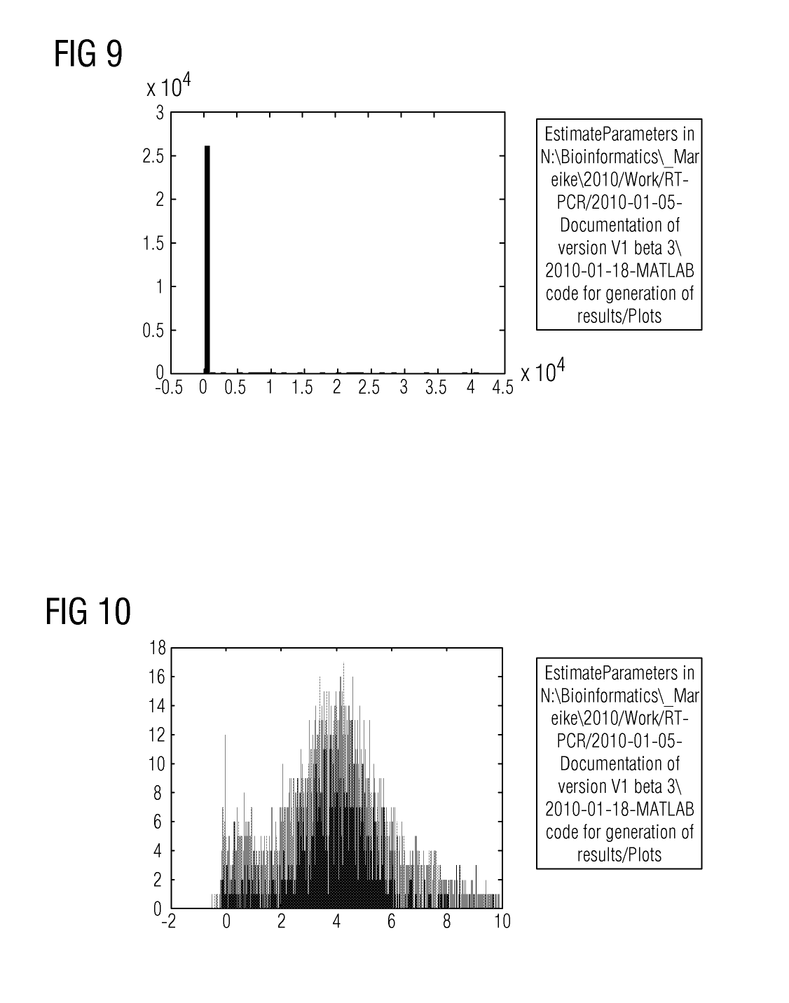

This problem can be solved by forcing the pedestal height to a predetermined value. Once the magnitude of a has been fixed, all remaining parameters can be estimated robustly, too. In optimization theory, this procedure is called regularization. Regularization of a raises the question which value is sensitive for a. In order to figure this value out, the data of 26640 RT-qPCR reactions belonging to the HECOG0309 study were fitted by a preliminary fitting algorithm that will not be described here. The fitting algorithm resulted in a set of five parameters (background intercept, background slope, pedestal height, sigmoid width and pedestal height) and a mean squared error for each of the 26640 reactions. The results of 436 curves were sorted out, because the corresponding Cₜ value was either an outlier or the operator responsible for the experiments marked the curve as “Bad”. A histogram of the values of the pedestal height for the remaining 26204 curves was plotted and is shown in FIG. 9.

FIG. 9: Histogram of Pedestal Height for HECOG0309

As can be seen when taking a closer look at this histogram, the majority of a values is smaller than or equal to ten. It is assumed that those values being larger than ten come from curves where most of the cycles belong to the background phase and thus aren't fitted robustly. Therefore they are sorted out as well, leading to a histogram which indicates that the pedestal height a should be forced to a value of approximately four, see FIG. 10.

FIG. 10: Histogram of Pedestal Height for HECOG0309 (Values Larger than Ten Sorted Out)

Computing the median of the remaining a values leads to

â=3.9110 (22)

where â denotes the value the pedestal height shall be regularized to.

A general regularization approach can be realized by expanding the minimization problem (20) by an additional summand.

$${min}_{c} {‖ f ( x , c ) - {R}_{n} ( x ) ‖}^{2} + {( c - \hat{c} )}^{t} \cdot weights \cdot ( c - \hat{c} ) \qquad ( 23 )$$

The purpose of the matrix weights is to determine how strict the regularization shall be. The larger an entry of weights, the higher is the effort of the fitting routine to force the corresponding value of c to equal its counterpart in ĉ, which consists of the parameter values we want to regularize to. Since we only want to regularize parameter a in a univariate way the matrix weights consists of only one non-zero entry. To balance both summands in problem (23) we normalize them by estimates of their variance.

$${min}_{c} \frac{{‖ f ( x , c ) - {R}_{n} ( x ) ‖}^{2}}{5.4674 \cdot {10}^{- 4}} + \frac{{( a - \hat{a} )}^{2}}{2.9518} \qquad ( 24 )$$

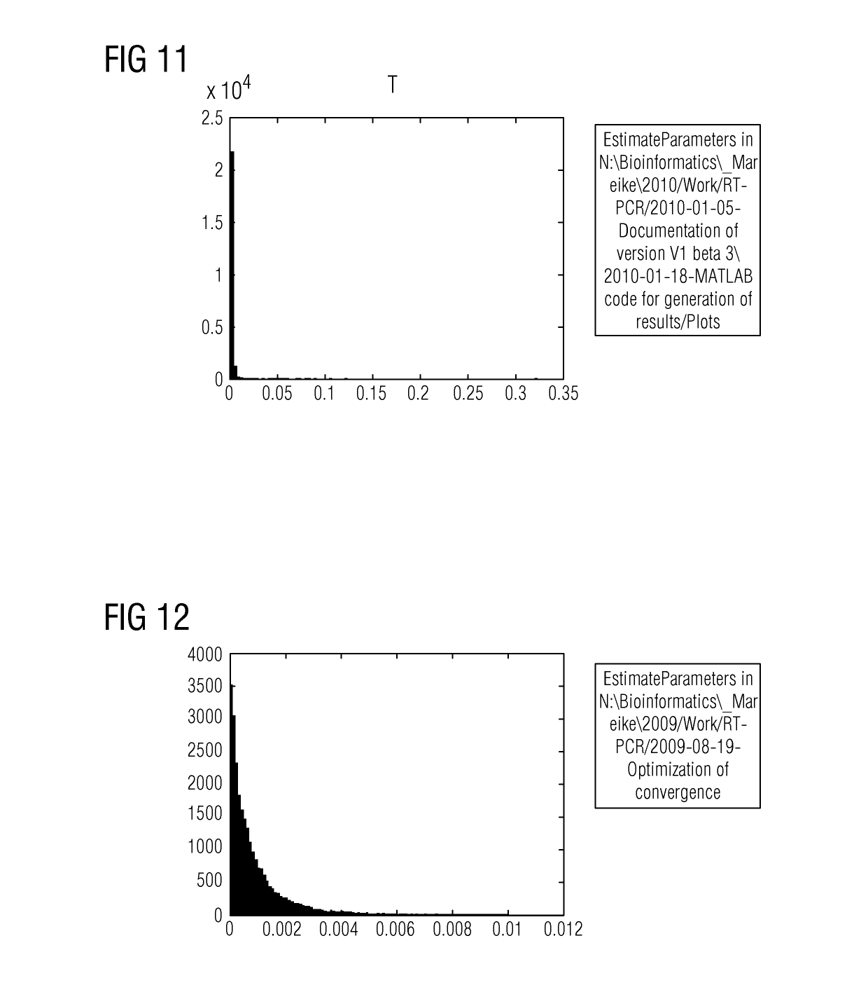

The first denominator in equation (24) was derived as follows: A histogram of the values of the mean squared errors of the same 26204 HECOG0309 curves as used for the determination of â was plotted and is shown in FIG. 11:

FIG. 11: Histogram of Mean Squared Error for HECOG0309

As can be seen when taking a closer look at this histogram, the majority of mean squared error values is smaller than or equal to 0.01. Only considering these curves leads to a median value for the mean squared error of 5.4674·10⁻⁴, see FIG. 12.

FIG. 12: Histogram of Mean Squared Error for HECOG0303 (Values Larger than 0.01 Sorted Out)

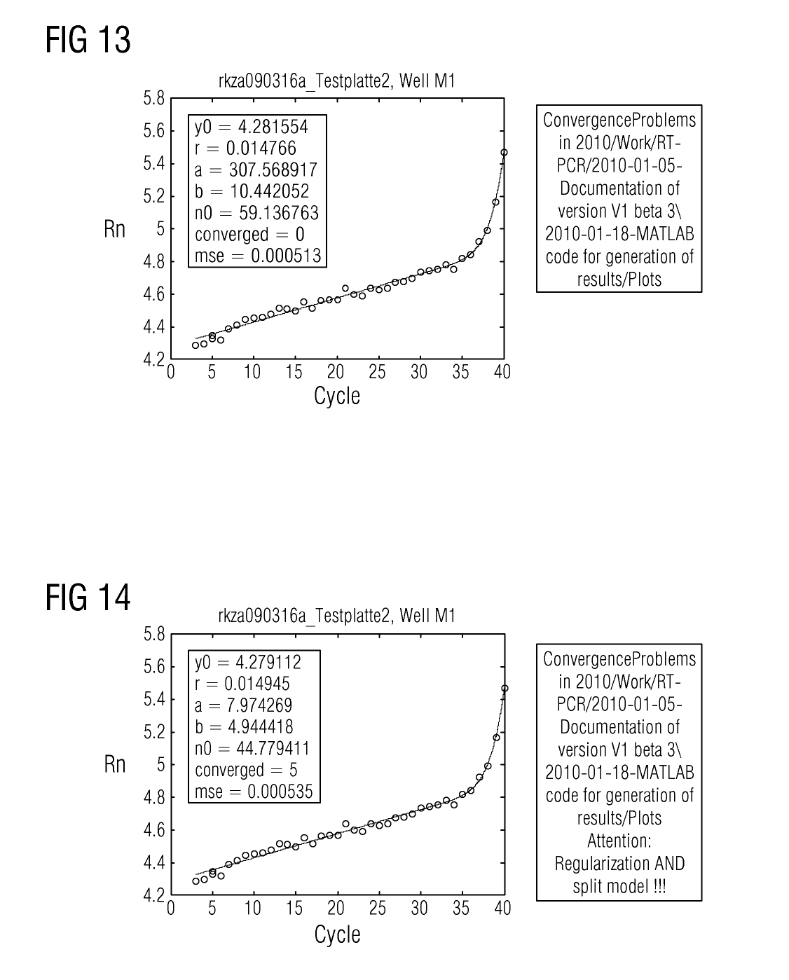

The usefulness of the regularization can be seen in the following example. FIG. 13 shows the result of a fit without regularization. One can see that parameter a grows to an extremely unrealistic value of 307.6 without regularization. The fitting routine does not converge and the resulting parameters are not meaningful.

FIG. 13: Example of a Regression without Regularization

Here, a regularization of the pedestal height leads to parameters which are more trustable. In addition, convergence of the fitting routine is achieved, see FIG. 14.

FIG. 14: Data of FIG. 13 with Regularization

Please note that—compared to the unregularized approach—the shape of the model curve is nearly unchanged but parameter a is much more realistic.

### 2.3.3. Constraints

One class of (RT-)qPCR curves which is difficult to handle are those curves which mainly consist of background and are thus quite linear. A fitting concept that can be used to achieve good fitting results even for these fluorescence data curves is the application of a special constraint which forces the optimization routine to introduce a nonlinearity into the data. When having specified this constraint, the fitting routine is forced to find parameter values in such a way that the condition given by the constraint is fulfilled. Whenever the constraint is violated a new set of parameters has to be chosen. In the current situation, the constraint is chosen as follows:
The term

$$gomp ( {x}_{i} ) = exp ( - exp ( - \frac{{x}_{i} - {n}_{0}}{exp ( β )} ) )$$

is calculated for each cycle and the linear regression

$$Xc = y$$

$$with$$

$$c = ( \begin{matrix}intercept \\ slope\end{matrix} ) X = ( \begin{matrix}1 {x}_{1} \\ 1 {x}_{2} \\ …\end{matrix} ) y = ( \begin{matrix}gomp ( {x}_{1} ) \\ gomp ( {x}_{2} ) \\ …\end{matrix} )$$

is solved.
The linearity norm is defined as the largest absolute difference between regression line and data:

$$linearityNorm = {max}_{i} ( \vert gomp ( {x}_{i} ) - ( slope \cdot {x}_{i} + intercept ) \vert ) \qquad ( 25 )$$

It is a measure for the linearity of the mapping

$${x}_{i} \to exp ( - exp ( - \frac{{x}_{i} - {n}_{0}}{exp ( β )} ) ) :$$

The more linear the mapping, the smaller the value of the linearity norm.
In order to introduce a nonlinearity to the data one has to forbid a choice of parameters that leads to a very small value of the linearity norm. Therefore the constraint

linearityNorm≧10⁻³
is specified. This constraint is not very limiting: In all 28800 RT-qPCR reactions carried out for the HECOG0309 study the value of the linearity norm was greater than 6·10⁻³. From this point of view, the introduction of the parameter linearityNorm seems to be dispensable, but on the one hand one has to keep in mind that the border for the linearity norm has possibly been reached during the optimization routine (thus preventing the optimizer from taking the wrong direction) and on the other hand it serves another purpose: As described above, curves characterized by a small value of the linearity norm are quite linear even in the exponential growth phase. Curves which are linear over the whole range of cycles have to be called “Undetected”, therefore the linearity norm will be used when defining the C_{q} value in paragraph 2.4.

### 2.3.4. Number of Cycles Used

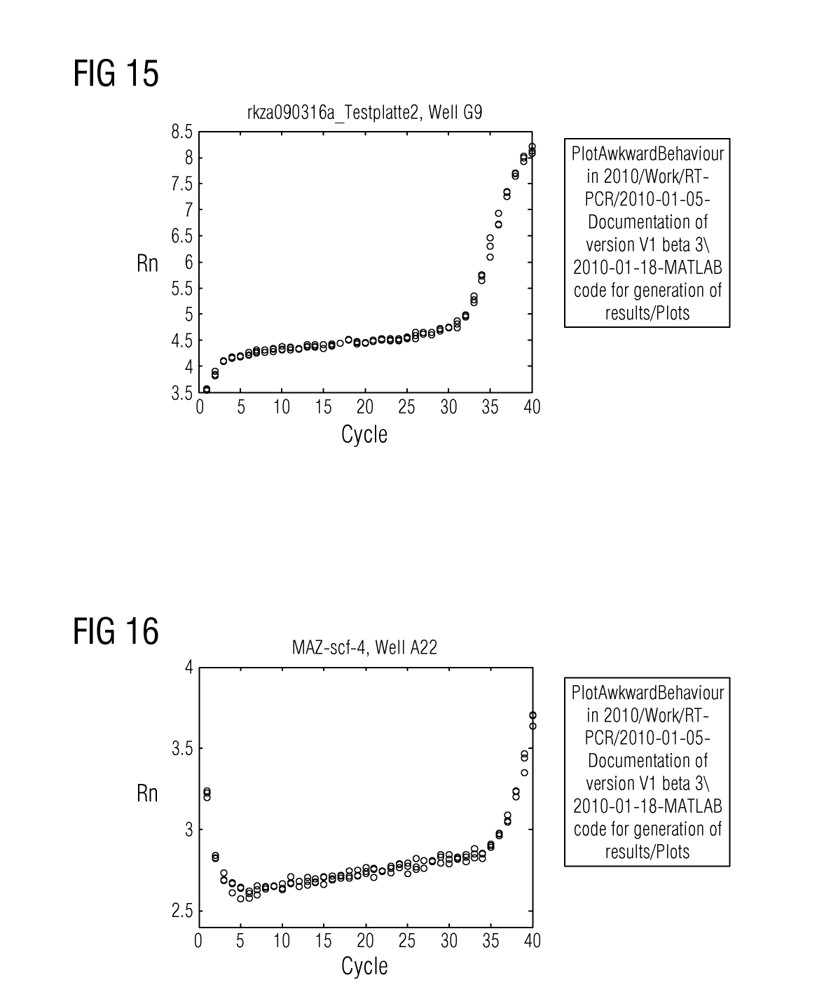

The next question that arises is how many cycles should be used for the fitting procedure. Preferably all cycles should be used, of course, but since there are many curves which show an awkward behavior in the first cycles (immoderate increase or decrease of Rₙ values, waves) the first two cycles are left out of the fitting process for all curves. Examples for the aforementioned awkward behavior are shown in the following FIGS. 15-17:

FIG. 15: Immoderate Increase of Rₙ Values in First Cycles

FIG. 16: Immoderate Decrease of Rₙ Values in First Cycles

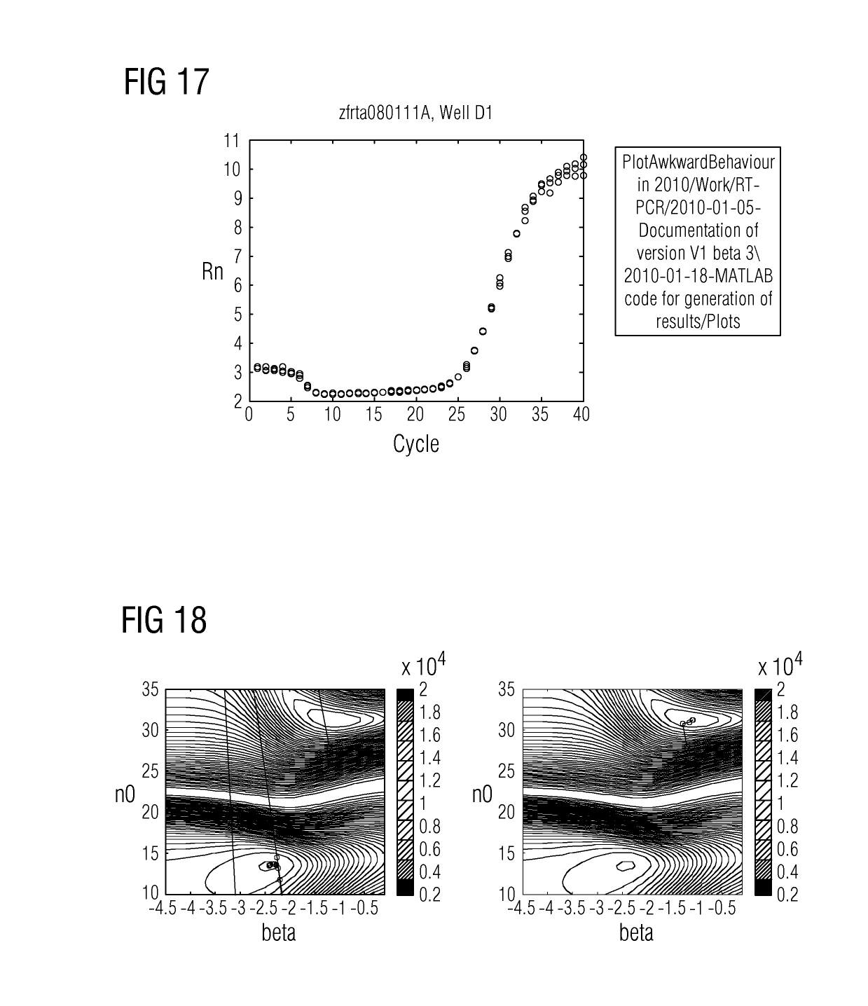

FIG. 17: Awkward Behavior in First Cycles (Wave)

While the data shown in FIG. 15 seem to be normal after having left out the first two cycles, the data in FIG. 16 and especially in FIG. 17 are abnormal even beyond the second cycle. One possibility to solve this problem would be to leave out more than two cycles from the first. This is not desirable, because for the majority of Rₙ curves the third cycle is usable and one should use as much data as possible for data fitting procedures. The solution used instead is to apply the fitting routine on the mean of all but the first two cycles and investigate afterwards if
the deviation between model and data for the first cycle used is high compared to the mean squared error of the fit and
the fit is good on the whole.

In other words

$$\begin{matrix}mse = \frac{{‖ f ( x ) - {R}_{n} ( x ) ‖}^{2}}{\# cycles used} \\ and & ( 26 ) \\ \vert f ( {x}_{1} ) - {R}_{n} ( {x}_{1} ) \vert & ( 27 )\end{matrix}$$

are computed where ƒ denotes the Gompertz function defined in equation (19) and x₁ denotes the first cycle used in the corresponding fit (not the first cycle measured). Whenever one of the conditions

$$\begin{matrix}log ( mse ) \geq - 4 \\ or & ( 28 ) \\ \frac{\vert f ( {x}_{1} ) - {R}_{n} ( {x}_{1} ) \vert}{\sqrt{mse}} > 3 & ( 29 )\end{matrix}$$

is fulfilled, the fit is doubted and the whole procedure (model fit and investigation of goodness-of-fit) is repeated for all data but the first three cycles. This process is iterated (leaving more and more first cycles out) until either the fit is good enough or no data are left. For the data shown in the figures above, the fit is not rejected when beginning with cycle three (FIG. 15), five (FIG. 16) and eight (FIG. 17).

### 2.3.5. Optimization Procedure

To be able to fit the Gompertz function to each given set of normalized (RT-)qPCR fluorescence data and to obtain a set of parameters y₀, r, a, β, and n₀ which is really suited to describe the data, some more technical considerations have to be made. First of all, one has to decide if it is better to optimize all parameters at once or to start with, for example, those two parameters characterizing the background (y₀ and r) and optimize those parameters characterizing exponential growth and plateau phase (a, β, and n₀) later. Since there is no biological indication why one should fit background and exponential growth/plateau separately, the holistic approach should be preferred. Unfortunately, especially for curves representing experiments with low target concentrations where most of the cycles belong to the background phase this approach fails because the regression often converges to a meaningless set of parameters or doesn't converge at all. In order to solve this problem and force the regression routine to converge at meaningful parameter values one has to have a closer look on the minimization problem given in (24),

$${min}_{c} \frac{{‖ f ( x , c ) - {R}_{n} ( x ) ‖}^{2}}{5.4674 \cdot {10}^{- 4}} + \frac{{( a - \hat{a} )}^{2}}{2.9518} .$$

When inserting the Gompertz function for ƒ one sees that the term that has to be minimized is a quadratic form of parameters y₀, r, and a; thus these parameters can be obtained by a regularized linear regression for fixed β and n₀. The technical advantage is that for fixed β and n₀ parameters y₀, r, and a can be optimized analytically by solving linear equations, see below. Taking this into account, the problem of fitting the Gompertz function to the Rₙ values can be reduced to a nonlinear optimization problem on only two parameters. In detail, the following is done: At first, the problem

$$\begin{matrix}{min}_{\tilde{c}} \frac{{‖ X \tilde{c} - y ‖}^{2}}{5.4674 \cdot {10}^{- 4}} + {( \tilde{c} - \hat{c} )}^{t} \cdot weights \cdot ( \tilde{c} - \hat{c} ) \\ with & ( 30 ) \\ X = ( \begin{matrix}1 & {x}_{1} & exp ( - exp ( - \frac{{x}_{1} - {n}_{0}}{exp ( β )} ) ) \\ 1 & {x}_{2} & exp ( - exp ( - \frac{{x}_{2} - {n}_{0}}{exp ( β )} ) ) \\ ⋮ & ⋮ & ⋮\end{matrix} ) , & ( 31 ) \\ \tilde{c} = ( \begin{matrix}{y}_{0} \\ r \\ a\end{matrix} ) , & ( 32 ) \\ y = ( \begin{matrix}{R}_{n} ( {x}_{1} ) \\ {R}_{n} ( {x}_{2} ) \\ ⋮\end{matrix} ) , & ( 33 ) \\ \hat{c} = ( \begin{matrix}0 \\ 0 \\ 3.9110\end{matrix} ) \\ and & ( 34 ) \\ weights = ( \begin{matrix}0 & 0 & 0 \\ 0 & 0 & 0 \\ 0 & 0 & \frac{1}{2.9518}\end{matrix} ) & ( 35 )\end{matrix}$$

is solved for fixed β and n₀ by computing the first derivative of the term to be minimized and setting it to zero:

$$0 = \frac{2 \cdot {X}^{t} X {\tilde{c}}_{opt} - 2 \cdot {X}^{t} y}{5.4674 \cdot {10}^{- 4}} + 2 \cdot weights \cdot ( {\tilde{c}}_{opt} - \hat{c} ) . \qquad ( 36 )$$

This leads via

$$\begin{matrix}\frac{2 \cdot {X}^{t} y}{5.4674 \cdot {10}^{- 4}} + 2 \cdot weights \cdot \hat{c} = ( \frac{2 \cdot {X}^{t} X}{5.4674 \cdot {10}^{- 4}} + 2 \cdot weights ) \cdot {\tilde{c}}_{opt} \\ to & ( 37 ) \\ {\tilde{c}}_{opt} = ( \begin{matrix}{( {y}_{0} )}_{opt} \\ {r}_{opt} \\ {a}_{opt}\end{matrix} ) = {( \frac{{X}^{t} X}{5.4674 \cdot {10}^{- 4}} + weights )}^{- 1} ( \frac{{X}^{t} y}{5.4674 \cdot {10}^{- 4}} + weights \cdot \hat{c} ) . & ( 38 )\end{matrix}$$

Afterwards, β and n₀ have to be chosen by the nonlinear fitting routine in such a manner that

$$res = \frac{{‖ f ( x , β , {n}_{0} , {\tilde{c}}_{opt} ( β , {n}_{0} ) ) - {R}_{n} ( x ) ‖}^{2}}{2 \cdot 5.4674 \cdot {10}^{- 4}} \qquad ( 39 )$$

gets minimal.

Another question that arises is which MATLAB function should be used to fit the Gompertz function to the fluorescence data. Since the function has to be able to handle the constraint described in paragraph 2.3.3 a routine called “fmincon” is chosen. It is a method based on gradients to find the minimum residual. Some more details on “fmincon” will be presented in paragraph 3.2. Among other things the fitting options that have to be used in the current situation are set there. It shall be mentioned that without specifying the parameters “TypicalX”, “RelLineSrchBnd” and “RelLineSrchBndDuration” the possibility of finding the wrong local minimum for res as defined in equation (39) is given. This is illustrated exemplarily in FIG. 18.

FIG. 18: Fit without (Left) and with (Right) Specification of Optimization Parameters “TypicalX”, “RelLineSrchBnd” and “RelLineSrchBndDuration”

### 2.3.6. Choice of Starting Value

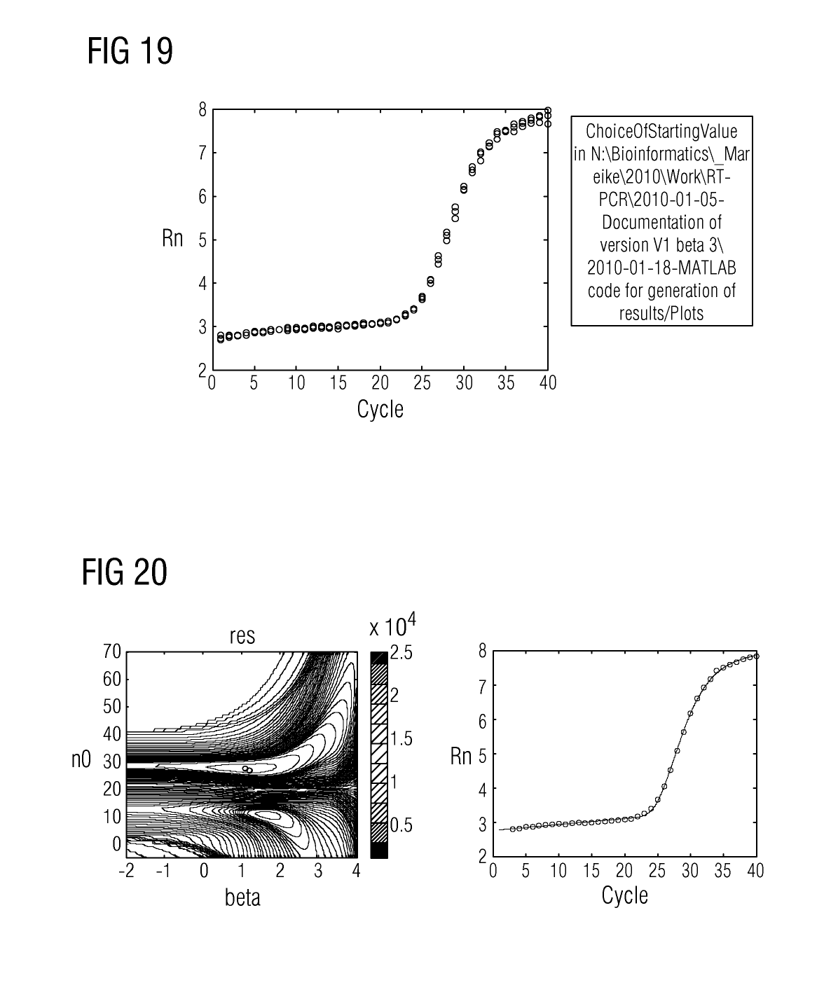

One crucial step in a fitting optimization is the choice of the starting value that is needed for all local optimization procedures. If this choice isn't skilled enough, the possibility of ending in a wrong local minimum is given. The starting value for β can be set to −log(0.3) for each (RT-)qPCR curve, finding an appropriate starting value for n₀ is more challenging. Considering the fluorescence data presented in FIG. 19, the cycle with the largest step in Rₙ seems to be a good guess for the inflexion point n₀. One can't determine this cycle exactly by hand, but it is obvious that it is between 25 and 35, see FIG. 19

FIG. 19: Fluorescence Data

A closer look on the residuals of the given data for fixed β and n₀ shows that this choice of starting values is sensible, because the minimum in which the optimization routine converges is suited to describe the data, see FIG. 20:

FIG. 20: Starting Point (Dark Gray Circle) and Point of Convergence (Light Gray Circle) for Optimization of Data in FIG. 19

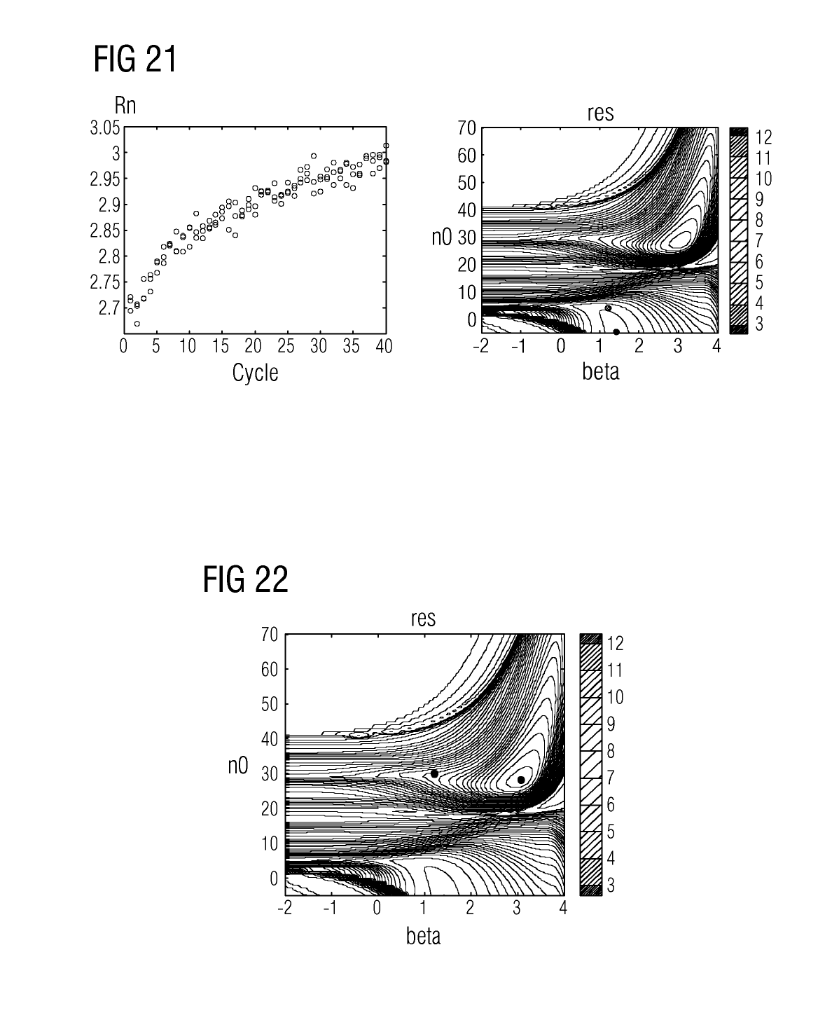

Nevertheless, a problem becomes apparent: In addition to the minimum that specifies the best choice for β and n₀ there is another local minimum in which the optimization routine could converge if the starting value for n₀ would be ten, for example. Converging in this second minimum is not desirable, because the resulting parameters would describe a Gompertz function with an inflexion point of approximately ten which is insensitive from a biological kind of view—fluorescence data of (RT-)qPCR reactions don't reach the exponential phase at these early cycles. The next figure illustrates an example of fluorescence data for which the choice of starting values as described above leads to convergence in the wrong minimum, see FIG. 21:

FIG. 21: Starting Point (Dark Gray Circle) and Point of Convergence (Light Gray Circle) in Wrong Minimum

This problem can be solved by slightly altering the definition of the starting value for n₀: The cycle with the largest step in Rₙ is replaced by the maximum of the aforementioned value and a constant value of 30. By forcing the algorithm to start with a value for n₀ that is greater than or equal to 30, the right minimum is found because it is not possible for the optimizer to cross the “mountains” between both minima, see FIG. 22:

FIG. 22: Altered Starting Point (Dark Gray Circle) and Point of Convergence (Light Gray Circle) in Right Minimum

### 2.4. Definition of C_{q} Value

The last step is to use the parameters gained by the optimization routine described in the last paragraphs to define a C_{q} value which provides information about the validity of an (RT-)qPCR curve and the amount of RNA or DNA in the sample. More precisely, there are four different classes the C_{q} value of each given example of fluorescence data can belong to, and these four classes have to be described by the parameters of the Gompertz function. In detail, a C_{q} value is either of
“Numeric”—If a well is neither labeled “Undetected” nor “Invalid” nor “Missing”, the C_{q} value is numeric and should be a measure for the amount of RNA or DNA in the sample. The formula for calculating this value—in the text below denoted as AIP value—has to rely on the parameters gained from the optimization, too.
“Undetected”—Labeling for a well with very low or zero target concentration. In this case all or most of the cycles belong to the background phase.
“Invalid”—Labeling for a well resulting in a curve with an abnormal shape which can't be trusted. A well is also labeled “Invalid” in case the fitting procedure didn't work properly. Another reason for a well to be labeled “Invalid” is that any of the cycles used for the fitting process lacks of a valid Rₙ value—due to missing measurements or due to all repeats being outliers.
“Missing”—Labeling for a well which was completely unused or in which either reporter dye or passive reference dye was missing. A well is also labeled as “Missing” if either the cycle layout does not equal the default (e.g. three repeated measurement for 40 cycles if TaqMan was used or one measurement for 50 cycles if MX3005 was used) or any of the fluorescence data of reporter dye or passive reference dye is missing or invalid. (Obviously, in contrast to the other classes this one does not depend on the parameters but only on the raw fluorescence data.)

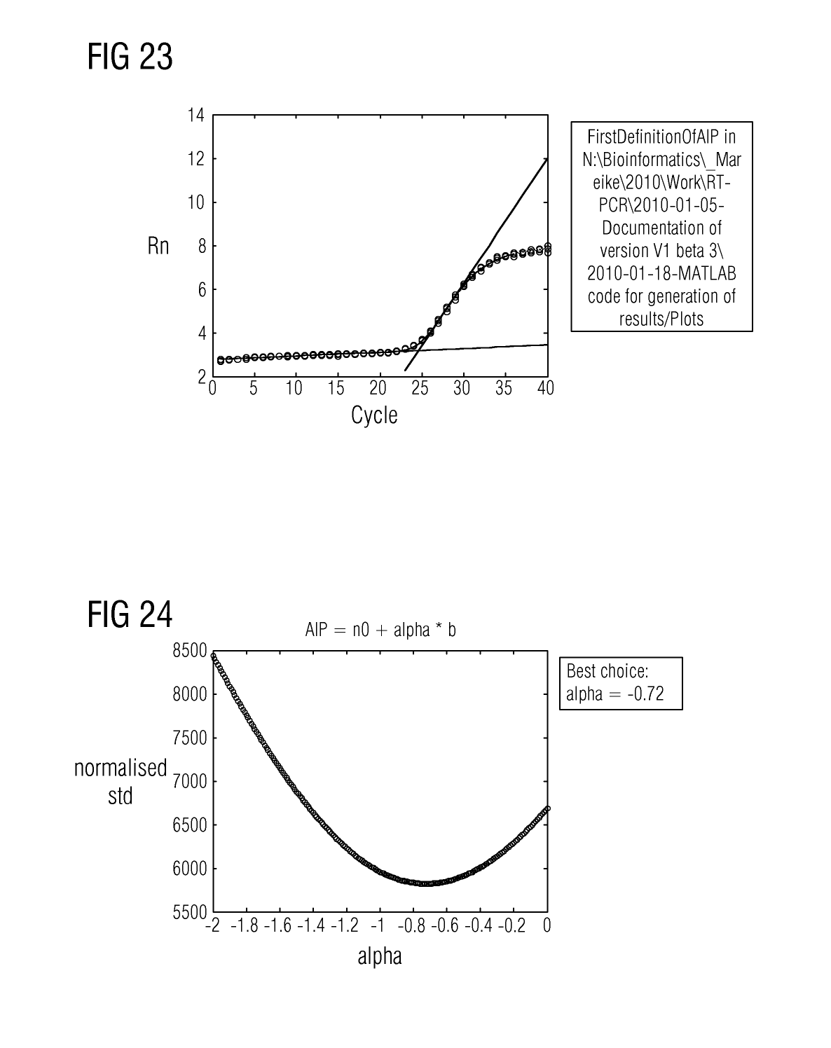

The first idea to calculate the AIP value was to determine the fractional cycle at which the tangent in the inflexion point crosses the background as illustrated in FIG. 23:

FIG. 23: First Definition of AIP Value

Given any function \tilde{ƒ}, the formula for the tangent in any point x₀ is given by

g(x)=\tilde{ƒ}(x₀)+\tilde{ƒ}′(x₀)·(x−x₀) (40)

For being able to apply this to the inflexion point of the Gompertz function, one first has to compute the first derivative by twice using the chain rule:

$$\begin{matrix}{f}^{′} ( x ) = r + a \cdot exp ( - exp ( - \frac{x - {n}_{0}}{b} ) ) \cdot ( - exp ( - \frac{x - {n}_{0}}{b} ) \cdot ( - \frac{1}{b} ) ) \\ = r + \frac{a}{b} \cdot exp ( - exp ( - \frac{x - {n}_{0}}{b} ) - \frac{x - {n}_{0}}{b} ) .\end{matrix} \qquad ( 41 )$$

This leads to

$${f}^{′} ( {n}_{0} ) = r + \frac{a}{b} \cdot exp ( - exp ( 0 ) ) = r + \frac{a}{b \cdot exp ( 1 )}$$

and since the value of the Gompertz function in the inflexion point is

$$f ( {n}_{0} ) = {y}_{0} + r \cdot {n}_{0} + \frac{a}{exp ( 1 )}$$

the formula for the tangent in the inflexion point is given by

$$\begin{matrix}g ( x ) = {y}_{0} + r \cdot {n}_{0} + \frac{a}{exp ( 1 )} + ( r + \frac{a}{b \cdot exp ( 1 )} ) \cdot ( x - {n}_{0} ) \\ = {y}_{0} + \frac{a}{exp ( 1 )} \cdot ( 1 - \frac{{n}_{0}}{b} ) + ( r + \frac{a}{b \cdot exp ( 1 )} ) \cdot x .\end{matrix} \qquad ( 42 )$$

For computing the AIP value one no has to equalize equation (42) with the background:

$$g ( AIP ) = {y}_{0} + r \cdot AIP \\ ⇔ 0 = \frac{a}{exp ( 1 )} \cdot ( 1 - \frac{{n}_{0}}{b} ) + ( \frac{a}{b \cdot exp ( 1 )} ) \cdot AIP \\ ⇔ \frac{{n}_{0}}{b} - 1 = \frac{AIP}{b} \\ ⇔ AIP = {n}_{0} - b .$$

This definition makes clear where the notation AIP value comes from: AIP is the abbreviation for “adjusted inflexion point”. The question that will be answered below is: Is this definition of the AIP value the best choice or is there a better one?

The basic framework of the definition shall remain constant, this means the AIP value shall be computed by adjusting the inflexion point n₀, but perhaps the definition

AIP=n₀−α·b

works better for some α≠1. In order to determine the best value of α one has to create a measure for comparing different versions of an AIP value definition. For this purpose, the 26640 RT-qPCR reactions belonging to the HECOG0309 study which were already used for the determination of the regularization constants in section 2.3.2 were fitted by a preliminary fitting algorithm again. Of these 26640 reactions, three wells contain the same material at a time and form a so-called triplicate. This means, in each of these three reactions the same gene was measured for the same tissue sample, and therefore the results of these three measurements should be the same. Therefore, one could define that definition of the AIP value as best for which the sum of the standard deviations of the AIP value over all 8880 replicates is minimal:

$${min}_{α} {\sum }_{i = 1}^{8880} std ( AIP ( α , i , 1 ) , AIP ( α , i , 2 ) , AIP ( α , i , 3 ) ) ,$$

where AIP(α,i,j) denotes the AIP value of the j^{th} member of the i^{th} triplicate when using α. This approach is not entirely satisfying, because each of the 8880 triplicates gets the same weight. That's not sensitive, because there are triplicates which contain large amounts of RNA as well as others which only contain few RNA molecules. For the triplicates mentioned last a higher standard deviation of the AIP values is acceptable, while for triplicates with much RNA the standard deviation has to be small. Therefore, a weighting factor has to be introduced. This weighting factor makes use of the Cₜ values (from SDS software) because they are the only criterion at hand. It is defined as follows:
In each triplicate, outliers in the Cₜ values are identified and excluded from further analysis.
Those Cₜ values which are “Undetermined” are substituted by appropriate replacement values. Exemplarily, the first replacement value is gained by determining that value of x that minimizes

$${( \frac{{\sum }_{i = 1}^{\# Triplicates} Noise ( i ) - Std ( Triplicate i )}{\# Triplicates} )}^{2}$$

(43)
under the constraint x≧40, where

$$Triplicate i = ( \begin{matrix}First Replicate \\ Second Replicate \\ x\end{matrix} )$$

and Noise(i) denotes the noise of the corresponding triplicate of Cₜ values—determined by an accepted noise model specified in equation (44). Here, only those triplicates of the 26640 HECOG0309 curves are used which consist of two “Numeric” replicates and one “Undetected” replicate.
The mean of the Cₜ values, C̅ₜ, is calculated. If at least two Cₜ values of a triplicate were excluded, C̅ₜ is set to 40.
The standard deviation of the inherent noise of a triplicate is calculated via a noise model given by

Noise( C̅ₜ)=0.11+0.83·exp(0.36·( C̅ₜ−37)) (44)
The reciprocal noise serves as weighting factor: The higher the noise the more acceptable is a large standard deviation in the AIP values.

A total of 499 triplicates were additionally sorted out for different reasons, resulting in the following minimizing task to optimize the AIP value:

$${min}_{α} {\sum }_{i = 1}^{8880} \frac{std ( AIP ( α , i , 1 ) , AIP ( α , i , 2 ) , AIP ( α , i , 3 ) ) ,}{Noise ( {\overline{C}}_{t} ( i ) )} .$$

The minimum was found at α=−0.72, therefore the AIP value is defined by

AIP=n₀−0.72·b (45)

The determination of α is illustrated in FIG. 24:

FIG. 24: Determination of Alpha for the Definition of the AIP Value

The next step is to decide for each fluorescence curve on the basis of the parameters gained by the optimization routine to which of the three classes—“Numeric”, “Undetected”, or “Invalid”—the corresponding C_{q} value belongs. As described above, the class “Missing” does not depend on the parameters but only on the raw fluorescence data. Whenever a well is classified as “Missing”, it's actually unnecessary to perform the fit, because its results are not needed.

Basis for the determination of the rules were the fitting results of the 28800 fluorescence curves belonging to the HECOG0309 study. Of these, 3600 curves were sorted out, because in the corresponding wells one of the genes ALCAM (SC312), MAP4 (SC083) or SPP1 (SC309) was measured and the results of these genes have to be doubted for some reason. The remaining 25200 curves were classified into three groups—
those with a numeric Cₜ value less than 40 (“Good” curves),
those with a Cₜ value greater than or equal to 40 (“Undetermined” curves), and
those with a missing Cₜ value (“Bad” curves, sorted out by the operator manually because of e.g. unusual shape).

Scatter plots of the distributions of parameter values resulting from the fitting routines were created, depicting curves “Good” by Cₜ as dark gray crosses, “Undetermined” by Cₜ as light gray crosses, and “Bad” by Cₜ as black crosses. These scatter plots were used to define the rules classifying curves into “Numeric” C_{q}, “Undetected” C_{q}, and “Invalid” C_{q}. Obviously, it is desirable to classify “Good” Cₜ as “Numeric” C_{q}, “Undetermined” Cₜ as “Undetected” C_{q}, and as few as possible curves as “Invalid” C_{q}. Nevertheless it is evident as well that this will not work for all 25200 curves. In addition there were also some rare cases where this equivalence between methods is not desirable, e.g. a curve with strongly increasing background, for which the Cₜ value is unreliable, but the AIP value is reliable. For some of the wells for which the classification based on Cₜ values on the one hand and on optimization results on the other hand differed we investigated whether or not this is problematic.

There were two kinds of rules that we defined—rough rules and fine rules. The purpose of the rough rules is to filter out curves for which at least one of the parameters is exceptionally high or low and classify them as “Invalid”. The fine rules separate curves whose parameters are in the normal range into the three classes; their determination was more challenging than just setting the rough rules.

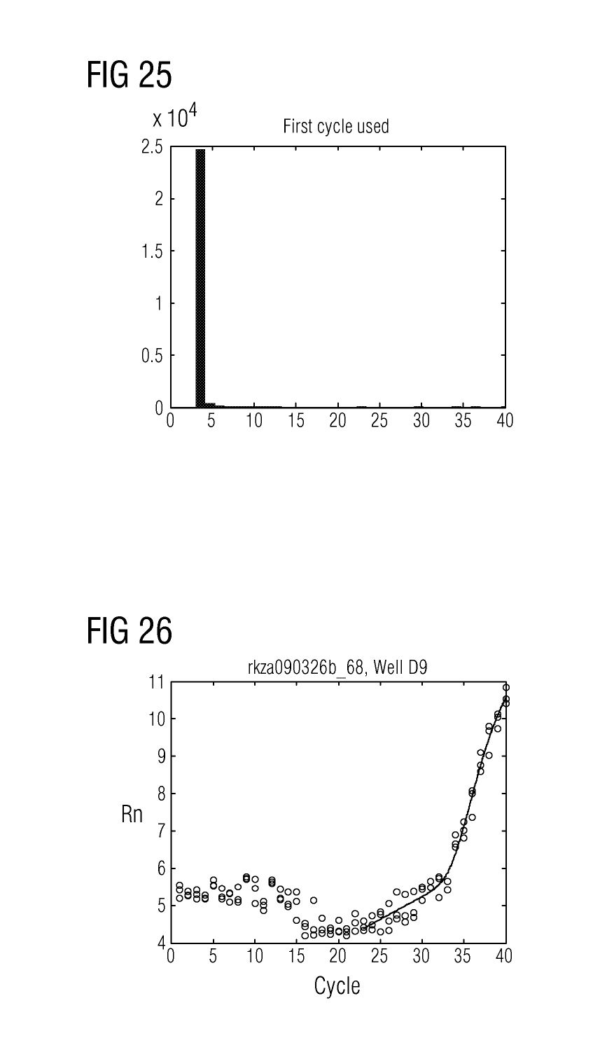

The first parameter that was investigated was the first cycle that was used for the Gompertz fit. As described in paragraph 2.3.4, this is the first cycle greater than two for which neither inequality (28) nor inequality (29) is fulfilled. The distribution of this parameter is shown in FIG. 25:

FIG. 25: Distribution of “First Cycle Used”

As can be seen in the histogram, for a majority of curves the first cycle which is used is smaller than ten. In detail, this is true for 99.96% of all curves. Those curves for which the fit starts with the tenth cycle or even later are classified as “Invalid”, because we evaluated these fits relying on too few data as not trustable:

First cycle used≧10 [symbol] C_{q}=“Invalid” (46)

By this rule, nine curves are called “Invalid”; five of them are “Bad” curves, the rest are “Good” curves. One of the “Good” curves is exemplarily shown in FIG. 26. Since the behavior of the curve in the first 20 cycles is awkward, the classification based on equation (46) is sensible although it doesn't agree with the Cₜ value, see FIG. 26.

FIG. 26: C_{q}=“Invalid”, Cₜ=30.46

In the next step further rough rules are determined.

2.4.1. Background Intercept Vs. Background Slope

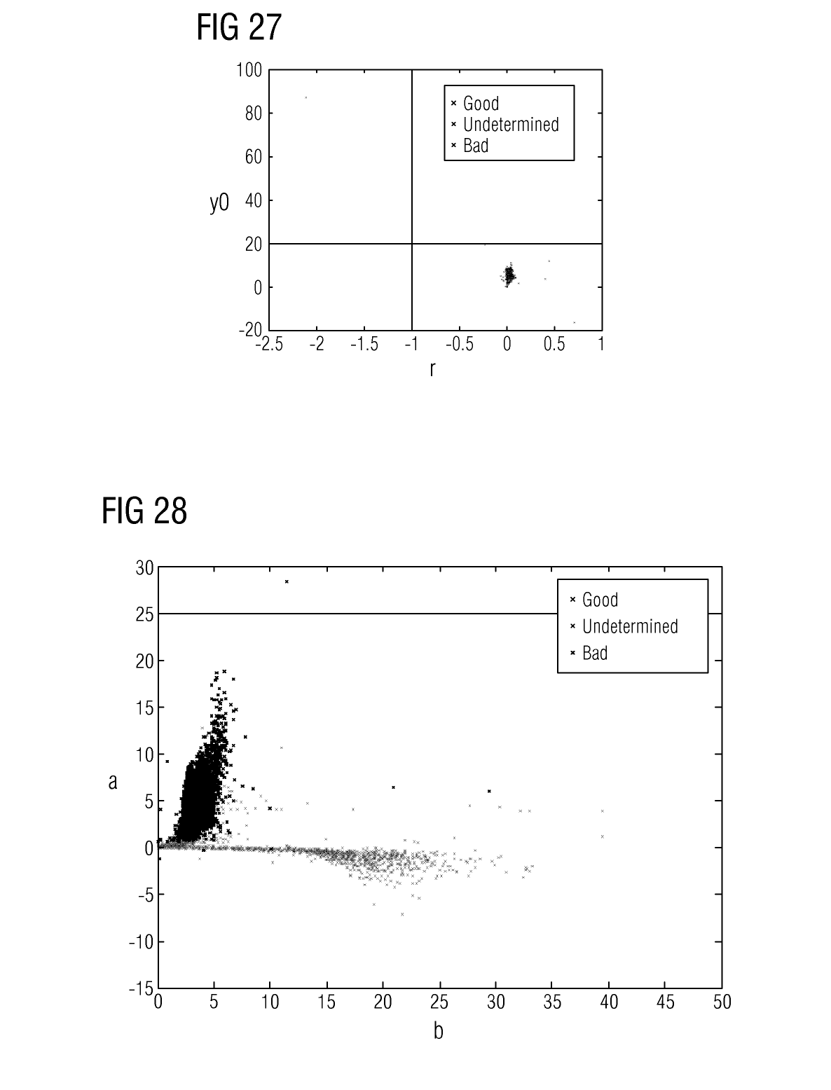

FIG. 27: Background Intercept Vs. Background Slope

The second and third rough rules are based on the parameters characterizing the background of the fluorescence data:

|y₀|>20 [symbol] C_{q}=“Invalid” (47)

|r|>1 [symbol] C_{q}=“Invalid” (48)

In the training data both rules characterize exactly the same curve as “Invalid”, this curve was classified “Bad” by the Cₜ value as well. The rules are also biologically sensible, because a rapid increase or decrease of the background (as given by a large absolute value of the background slope) as well as initial Rₙ values far from zero (as given by a large absolute value of the background intercept) indicate that something went wrong during the reaction.

2.4.2. Pedestal Height Vs. Sigmoid Width

FIG. 28: Pedestal Height Vs. Sigmoid Width

The rough rule for the sigmoid width b only has to provide an upper bound, since b is bounded below by zero due to its definition as exp(β):

a>25 [symbol] C_{q}=“Invalid”

a<−15 [symbol] C_{q}=“Invalid” (49)

b>50 [symbol] C_{q}=“Invalid” (50)

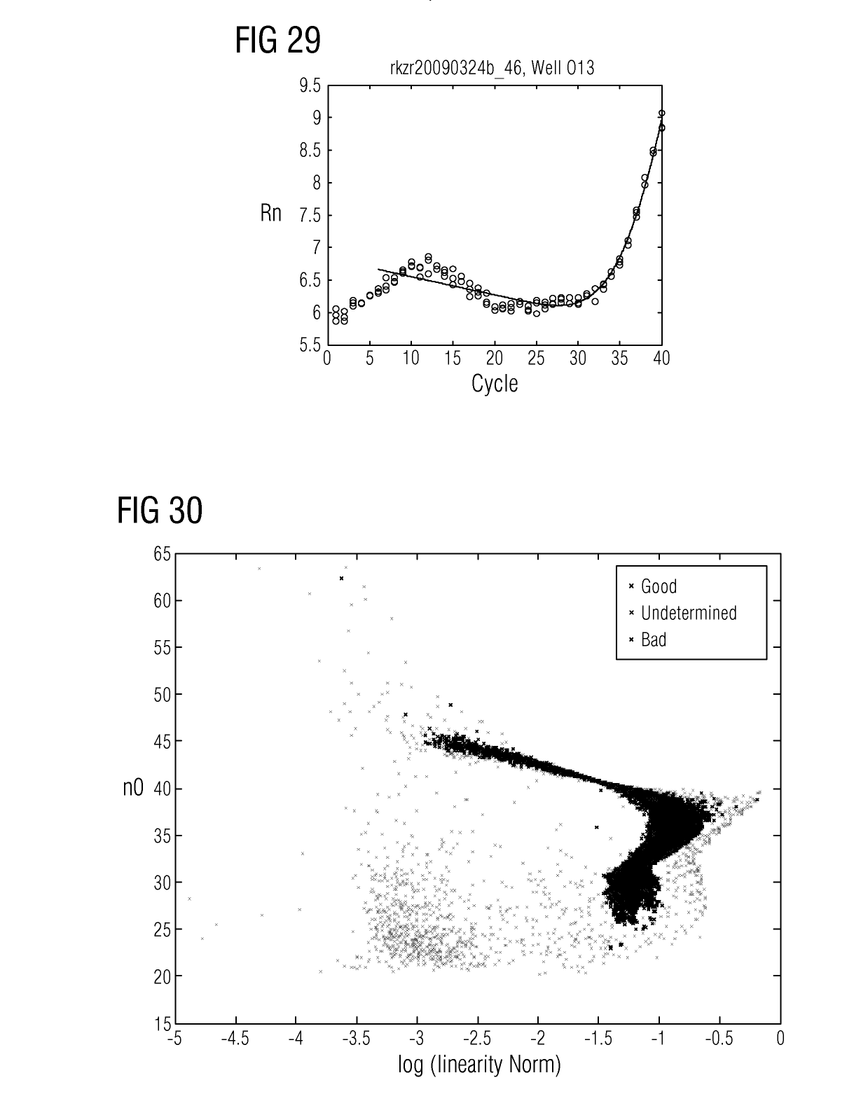

Again, these rules are also biologically sensible: A negative value of the pedestal height indicates that the plateau lies beyond the background level. This means a decrease of RNA or DNA molecules during the (RT-)qPCR reaction. Since this is impossible due to the principle of such a reaction, a pedestal height which is even negative has to be doubted. A sigmoid width b larger than 50 implies via equation (18) that the length of the exponential region exceeds 400. Such a curve has to be doubted, too. Exactly one curve fulfills rule (49), this curve has a “Good” Cₜ. As depicted in FIG. 29, this curve shows an awkward behavior in the first 20 cycles, therefore it's reasonable to call the curve “Invalid” and the deviation from the classification based on Cₜ values is not problematic, see FIG. 29.

FIG. 29: C_{q}=“Invalid”, Cₜ=38.57

No curve of the training data set is classified as “Invalid” by the rough rule depending on the sigmoid width.

2.4.3. Inflexion Point Vs. Logarithm of Linearity Norm

FIG. 30: Inflexion Point Vs. Logarithm of Linearity Norm

See FIG. 30, there is no need for a rough rule on the logarithm of the parameter linearityNorm, because it is bounded from below by log(10⁻³) due to the constraint during the fitting routine specified in paragraph 2.3.3. On the contrary, the inflexion point has to be bounded by a rough rule:

n₀>65 [symbol] C_{q}=“Invalid”

n₀<15 [symbol] C_{q}=“Invalid” (51)

From a biologically point of view this rules makes sense, too, because an inflexion point smaller than 15 would indicate that the reaction has reached the exponential phase at approximately cycle ten or even earlier. None of the 25200 HECOG0309 curves is caught by this rule. Taking together all rough rules and the rule on the first cycle which was used for the fitting routine, one gets a total of ten curves which are classified as “Invalid” so far. These curves will be left out for the derivation of the fine rules below.

2.4.4. Pedestal Height Vs. Logarithm of Linearity Norm

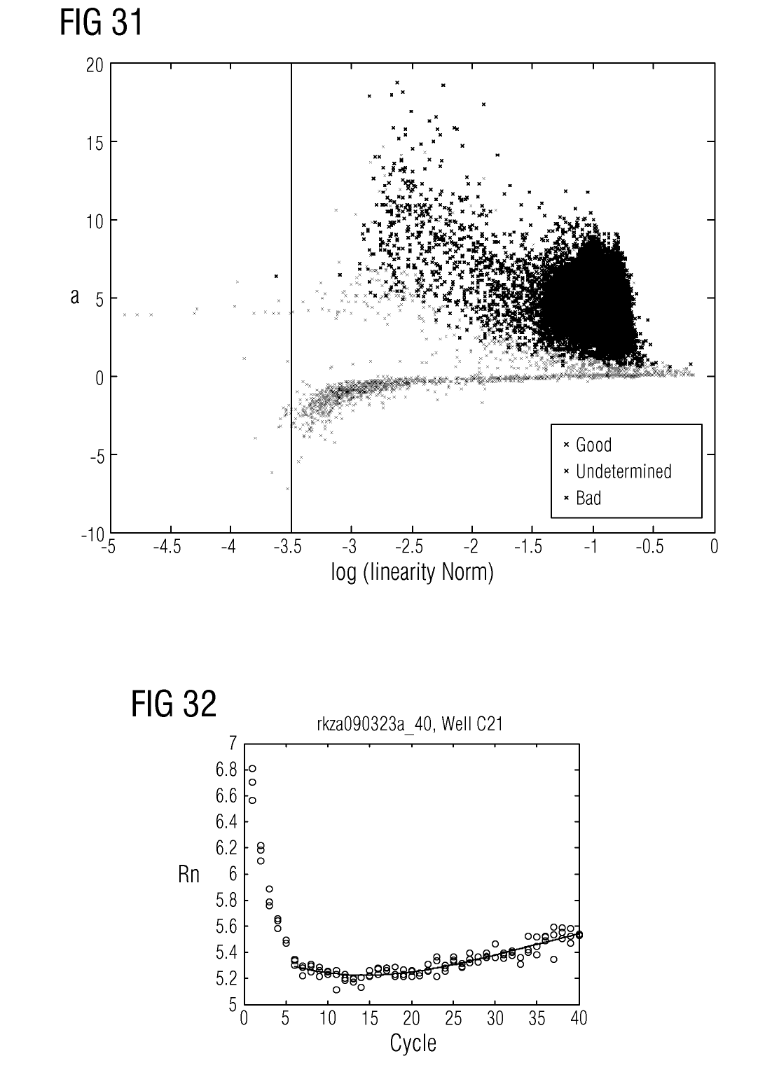

FIG. 31: Pedestal Height Vs. Logarithm of Linearity Norm

In FIG. 31, plotting the pedestal height a against the logarithm of the linearity norm shows that the linearity norm is appropriate to classify a part of the “Undetermined” curves as “Undetected”. That is not astonishing, because a small value for the linearity norm is equivalent to almost linear data, indicating that all cycles of the curve belong to the background region. The decision where to put the threshold depends on what shall be achieved with the rule. There are two possibilities:
Choose a threshold which covers a preferably large amount of “Undetermined” curves (for example −2.9), having the disadvantage of classifying some curves as “Undetected” which really are “Good” curves. A further disadvantage is that a threshold of −2.9 would be very close to the main cluster of points, leading to a rule that is not very robust.
Choose a threshold which covers only a small amount of “Undetermined” curves (for example −3.5) resulting in fewer “false” classifications.

Since there are more parameters which can help to classify a curve as “Undetected”, the second option was chosen here:

log(linearityNorm)≦−3.5 [symbol] C_{q}=“Undetected” (52)

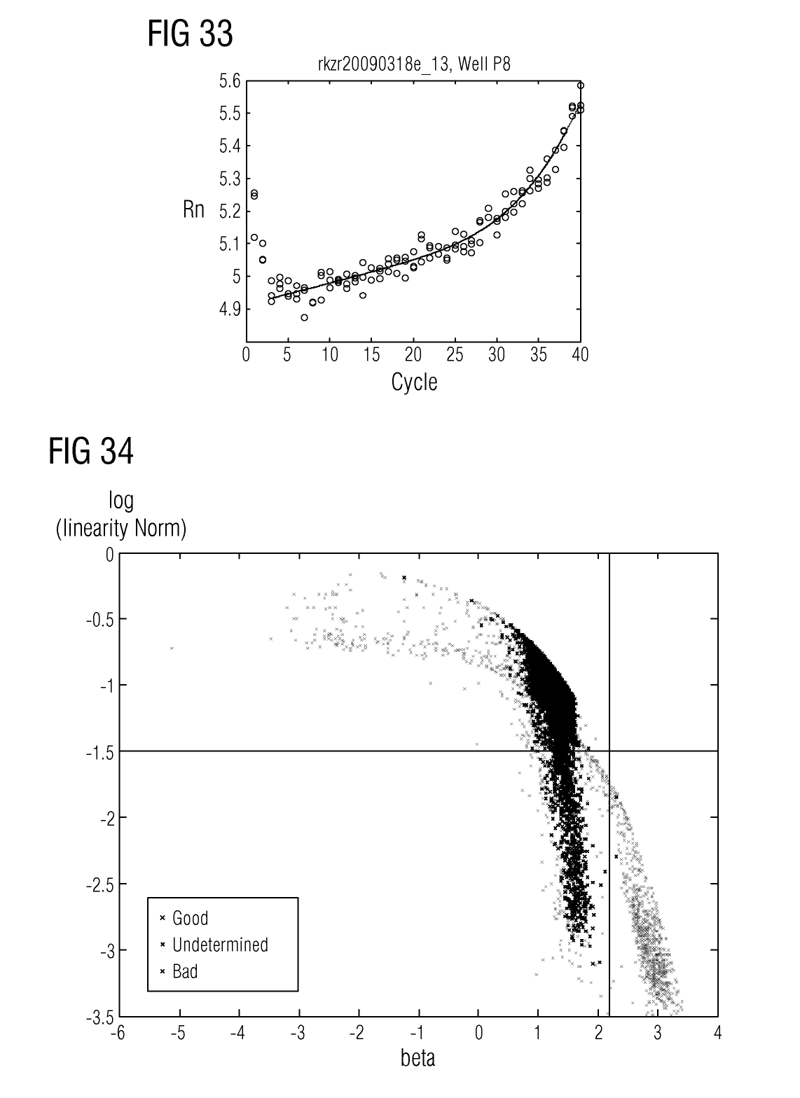

A total of 31 curves are classified as “Undetected” by this rule. Of these, 29 have “Undetermined” Cₜ; the other two fluorescence data plots are shown in FIG. 32 and FIG. 33:

FIG. 32: C_{q}=“Undetected”, Cₜ=“Bad”

For this curve in FIG. 32, the classification as “Undetected” is as sensible as the categorization into “Bad”. On the one hand one can leave the first five cycles out, getting a curve which obviously consists of background only; on the other hand one can take all cycles into account and sort out the curve because its behavior in the first cycles is awkward.

FIG. 33: C_{q}=“Undetected”, Cₜ=38.89

It's not wrong to classify this curve as “Undetected”, because all cycles belong to the background phase and the beginning of the exponential region. In addition, computing the AIP value of this curve leads to 47.18; the curve in FIG. 33 would thus be classified as “Undetected” by the rule (57) (see below) that will be presented below even if the threshold for the logarithm of the linearity norm was smaller.

Those 31 curves being classified as “Undetected” by the rule on the logarithm of the linearity norm will be left out for the further analysis. Since FIG. 31 shows that the linearity norm is a suitable parameter for the classification of many “Undetermined” Cₜ curves, we investigated whether more curves can be separated in combination with the sigmoid width. To understand the plausibility of this consideration one has to keep in mind that a large value for b is equivalent to the fact that many cycles belong to the exponential region, resulting in a very drawn-out curve.

2.4.5. Logarithm of Linearity Norm Vs. Logarithm of Sigmoid Width

FIG. 34: Logarithm of Linearity Norm Vs. Logarithm of Sigmoid Width

The FIG. 34 shows that “Undetermined” curves are characterized by a small linearity norm in combination with a large sigmoid width:

$$\begin{matrix}log ( linearityNorm ) \leq - 1.5 \\ β \geq 2.2\end{matrix} \} ⇒ {C}_{q} = {}_{}^{“}{Undetected}{}_{}^{”} \qquad ( 53 )$$

Of the 829 curves which are classified as “Undetected” by this rule, 827 have a Cₜ value which is “Undetermined”.

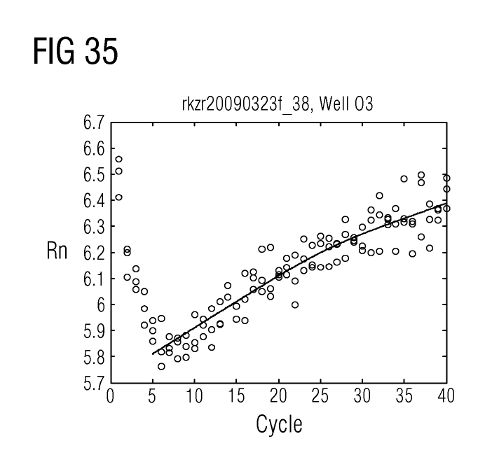

The other two curves are “Bad”; one of them is exemplarily shown in FIG. 35:

FIG. 35: C_{q}=“Undetected”, Cₜ=“Bad”

Obviously, both classifications are sensible for this curve, for the same reason as for the data shown in FIG. 32. The 829 curves which come within the last rule are sorted out for the further analysis again.

2.4.6. Pedestal Height Vs. Adjusted Inflexion Point

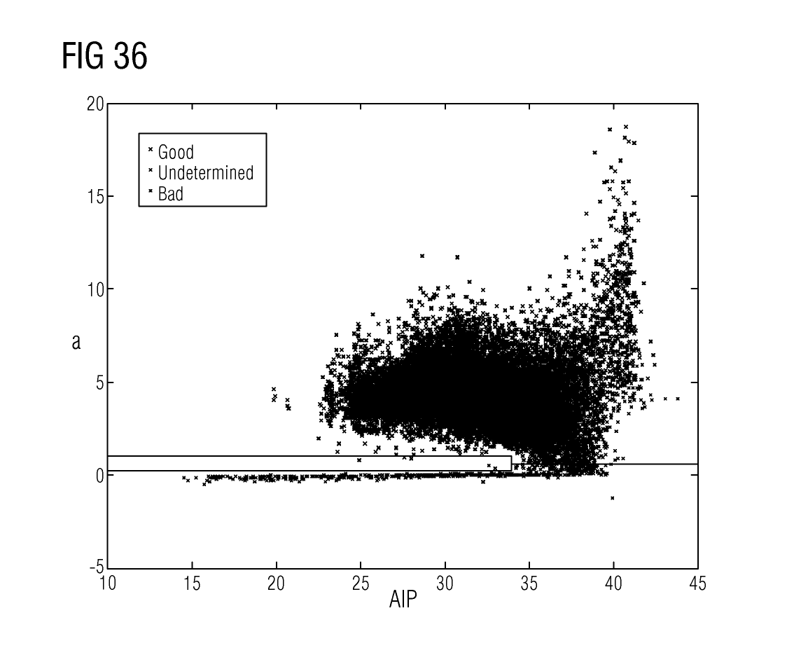

FIG. 36: Pedestal Height Vs. AIP

The scatter plot in FIG. 36 shows that the combination of pedestal height and adjusted inflexion point is another means to characterize “Undetermined” curves. A high AIP value in coincidence with a low pedestal height leads to the classification “Undetected”:

$$\begin{matrix}AIP \geq 34 \\ a \leq 0.6\end{matrix} \} ⇒ {C}_{q} = {}_{}^{“}{Undetected}{}_{}^{”} \qquad ( 54 )$$

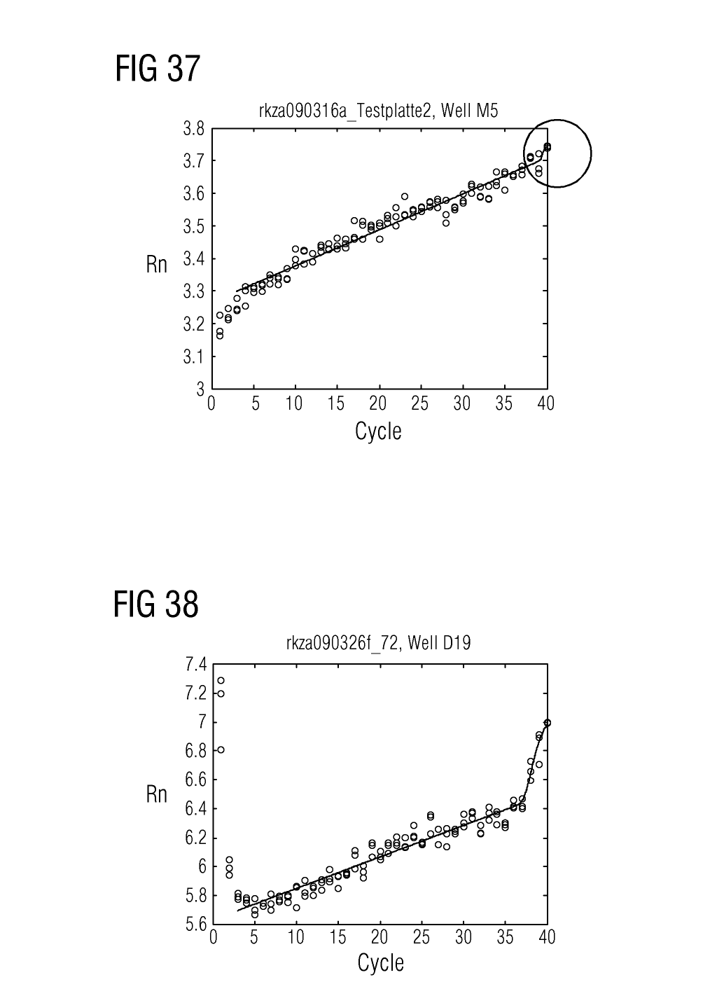

This is not amazing, because a low pedestal height indicates that the amount of molecules in background phase and plateau phase is not very different. This could mean that the exponential phase detected in the data doesn't imply that the curve really has a sigmoid shape. All cycles might as well belong to the background phase and the detection of the exponential phase might be pure chance. This situation is shown exemplarily in FIG. 37:

FIG. 37: C_{q}=“Undetected”, Cₜ=“Undetermined”, a=0.0366

A total of 247 curves is classified as “Undetected” by this rule, 245 of them belong to the class “Undetermined” Cₜ. The other two curves have Cₜ values of 39.5865 and 38.0806 respectively. One of the curves is shown exemplarily in FIG. 38. Obviously it is not wrong to classify this curve as “Undetected”, because all cycles belong to the background phase and the beginning of the exponential region. In addition, computing the AIP value leads to 37.43 and it doesn't really make any difference if a curve is classified as “Undetected” or is characterized by a “Numeric” AIP value close to 40, see FIG. 38.

FIG. 38: C_{q}=“Undetected”, Cₜ=38.08, a=0.5388

The question that remains is what to do with curves that are characterized by a small pedestal height and a small AIP value. A closer look on FIG. 36 reveals that they should be classified as “Undetected”, too. Since in the HECOG0309 data there are almost no curves with an AIP value smaller than 34 and a concurrent pedestal height between 0.2 and one, curves characterized by this combination of parameters are classified as “Invalid”. This leads to the following two rules:

$$\begin{matrix}\begin{matrix}AIP < 34 \\ a \leq 0.2\end{matrix} \} ⇒ {C}_{q} = {}_{}^{“}{Undetected}{}_{}^{”} & ( 55 ) \\ \begin{matrix}AIP < 34 \\ 0.2 < a < 1\end{matrix} \} ⇒ {C}_{q} = {}_{}^{“}{Invalid}{}_{}^{”} & ( 56 )\end{matrix}$$

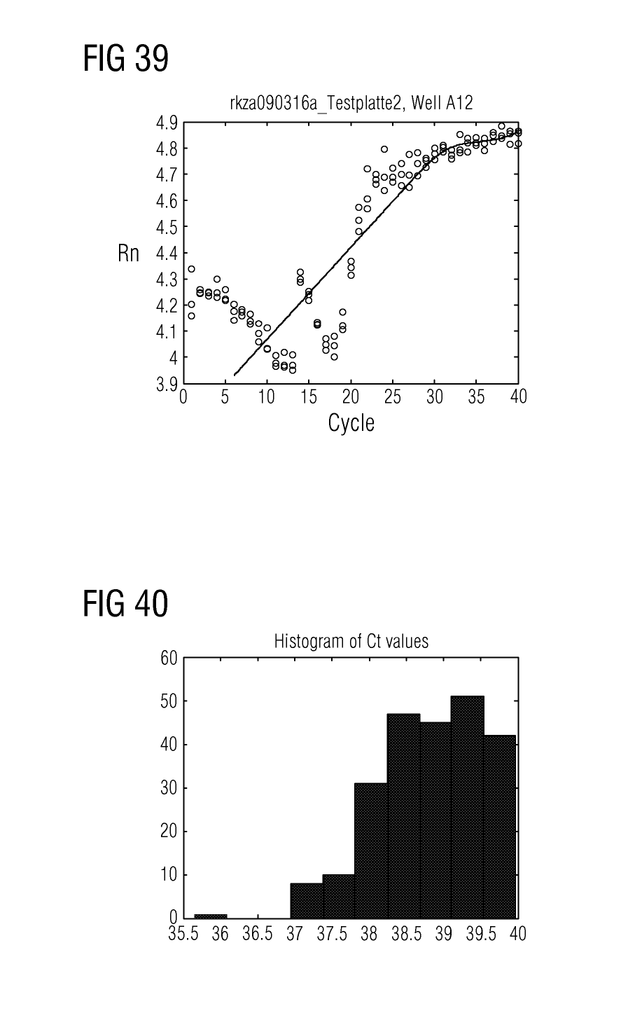

Rule (55) classifies 361 curves as “Undetected”. Of these, all except one curve have “Undetermined” Cₜ. The exceptional case is depicted in FIG. 39.

FIG. 39: C_{q}=“Undetected”, Cₜ=“Bad”, a=−0.3550

Though a classification as “Invalid” would be better it is maintainable to characterize it as “Undetected”. A closer look on FIG. 36 also reveals that the curve shown in FIG. 39 has one of the lowermost pedestal heights. Therefore, when achieving to characterize “Undetected” curves by a small value of the parameter a, one can't avoid a misclassification of this curve. Only five curves are classified as “Invalid” by rule (56), two of these curves are “Bad”, two curves are “Undetermined” and one curve is “Good”. They won't be analyzed in detail here. Those 613 curves being classified as “Undetected” or “Invalid” by the rules in this paragraph are left out of the further analysis again.

The last rule that has to be defined is an upper border for the AIP value. This border is set to 40:

AIP≧40 [symbol] C_{q}=“Undetected” (57)

A total of 355 curves were classified as “Undetected” by this rule. Only 103 of them belong to the class “Undetermined” Cₜ, 17 of them are “Bad”. As can be seen in FIG. 40, the majority of Cₜ values of those curves classified “Good” are close to 40, therefore rule (57) is sensible anyway, see FIG. 40.

FIG. 40: Histogram of Cₜ Values for Curves Being Classified as “Undetected” by Rule (57)

### 2.5. Comparison of C_{q} Values and Cₜ Values

A comparison of the results of C_{q} values and Cₜ values results in the following table:

| | C_{q} | | |
|---|---|---|---|
| Cₜ | “Numeric” | “Undetected” | “Invalid” |
| Value (“Good” curves) | 22818 (90.55%) | 238 (0.94%) | 6 (0.02%) |
| “Undetermined” curves | 271 (1.08%) | 1564 (6.21%) | 2 (0.01%) |
| “Bad” curves | 273 (1.08%) | 21 (0.08%) | 7 (0.03%) |

This means for a total of 96.79% both methods result in equivalent classifications. Please note that “Numeric” C_{q} and “Good” Cₜ should match as well as “Undetected” C_{q} and “Undetermined” Cₜ should match; “Invalid” C_{q} and “Bad” Cₜ must not necessarily match since the (subjective) criteria for a reliable Cₜ value are very different from the criteria for a reliable C_{q} value due to very different calculation approaches.

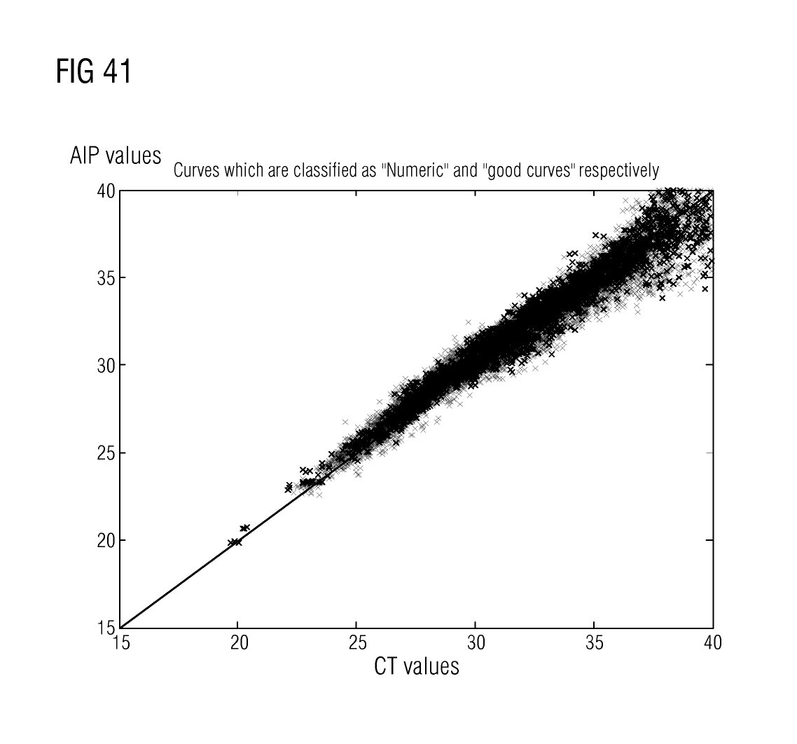

When taking a closer look at those wells which the C_{q} method as well as the Cₜ method classify as “Numeric” and “Good”, respectively, one realizes that on the lower end of the scale AIP values are greater by trend, while on the upper end the situation is vice versa, see FIG. 41.

FIG. 41: Analysis of all Genes

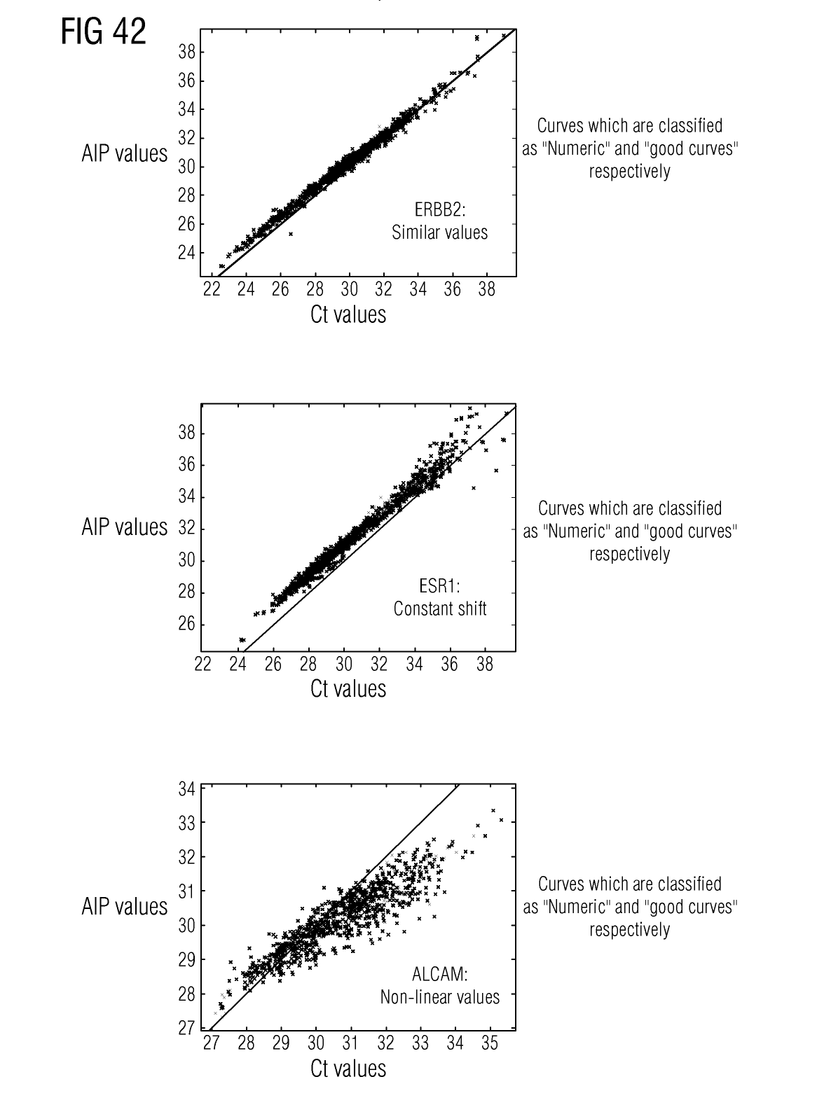

Analyzing the correlation between both methods for separate genes reveals that for some genes the methods result in similar values, while for other genes there is a constant shift and for the rest of the genes C_{q} values and Cₜ values are non-linear, see FIG. 42.

FIG. 42: Analysis of Separate Genes

### 3. TECHNICAL DETAILS

The purpose of the last chapter is to explicitly describe the details of the program that was implemented in MATLAB language to export fluorescence data of TaqMan or MX3005 experiments and fit those data to a Gompertz model in order to determine C_{q} values as a means to evaluate the results of an experiment. The program consists of three steps:
1. Import of fluorescence data.
2. Fitting of Rₙ curves.
3. Computation of C_{q} values.

The MATLAB implementation codes missing numeric data as NaN (not-a-number), which is a special value of the numeric data type “double”. In particular NaN codes missing repeats, outliers within repeats, missing fluorescence values of single cycles (pure dyes as well as Rₙ values), “Invalid” or “Missing” C_{q} values, and “Bad” Cₜ values. “Undetected” C_{q} values and “Undetermined” Cₜ values are coded as Inf (positive infinity), which also is a special value of data type “double”.

### 3.1. Import of Fluorescence Data

### 3.1.1. Using TagMan and SDS Software

Data Export from SDS Software

The program described in the next section expects txt-files of a certain structure which have to be exported from the SDS software manually. To be able to use the program, one has to use version 2.2, 2.2.2 or 2.3 of the SDS software. Other versions are not supported. To export the data from the SDS software, the first step is to push the “Analyze” button (marked by a green arrow). Afterwards, one has to choose “Export” in the “File” menu. In the graphical user interface which pops up, three changes have to be made:
1. In “Suchen in:” (German for “search in”) the directory in which the resulting txt-file shall be saved has to be chosen.
2. In the list box “Export:” the item “Multicomponent” has to be selected.
3. In the edit field “Dateiname:” (German for “file name”) the characters “mc” (for multi-component) have to be added to the end of the proposed filename.

The last step is to push the “Export” button; afterwards the SDS software isn't needed anymore. The txt-file which is exported satisfies the following structure:
The first line provides information about the SDS software which was used and about the form of export which was used (in this case “Multicomponent”).
The second line is a header for the different columns of the following lines, entitling them “Well”, “Time”, “Temp”, “Cycle”, “Step”, “Repeat”, “<dye>”, “BKGND—<well name>” and “mse/chan”. There can be more than one column entitled “<dye>” according to the number of reporter dyes, passive reference dyes and quencher dyes which were chosen by the operator who analysed the qPCR run. If, for example, the dye FAM is chosen as reporter, the dye ROX is chosen as passive reference and the dye TAMRA is chosen as quencher, there will be three columns instead of one, entitled “FAM”, “ROX” and “TAMRA”. An anomaly occurs when the Black Hole Quencher (BHQ) is chosen as quencher. In this case there is no column entitled “BHQ” since the Black Hole Quencher emits no fluorescence signal.
The following lines (usual 120) contain information about the first well used (in general, this is the well in the left upper border of the qPCR plate—called “1” or alternatively “A1”). All in all, a TaqMan plate consists of 384 wells, divided into 16 rows and 24 columns. The wells in the first row are denoted “A1”, “A2” etc., the wells in the second row are denoted “B1”, “B2” etc. and so on. When labelling the wells by a number from “1” to “384”, well “A1” is assigned the “1”, well “A2” is assigned the “2” and so on.
The first column is constant for all (usual 120) lines; it denotes the number of the well. To understand the following columns one has to realise that a TaqMan run consists of 40 cycles and that during each cycle three intensity measurements are performed. The column “Repeat” indicates which cycle is regarded in the current line and the columns “Time”, “Temp” and “<dye>” inform about the time and temperature at which the measurement was made and about the fluorescence intensity of the according dye. The other columns contain supplementary information which is unnecessary to understand for the purposes of this documentation.
The following lines can be skipped; the next line which is important is the header line for the block of intensity data for the next well.

### Data Import to MATLAB

The program which imports the data included in the txt-file to MATLAB is called “ImportSDSFileFromTXT”. It is called with five input parameters and two output parameters:

[expressionData, msg]=ImportSDSFileFromTXT(basename, reporter, passiveReference, directory, outputFunction).

The parameters “msg” and “outputFunction” are optional parameters which are only needed when the program is started from a GUI (graphical user interface). They won't be considered here. All obligatory input parameters have to fulfill certain conditions:
basename: Character array which denotes the plate that shall be processed. It has to be concordant with the name of the txt-file except that the two characters “mc” have to be missing.
reporter: Character array or 1*n cell array of strings which provides information about the reporter dye(s) used throughout the analysis. One or more dyes can be chosen. Possible values are “FAM”, “VIC”, “JOE”, “NED”, “SYBR”, “TAMRA”, “TET” and “ROX”. The program doesn't support the use of other dyes.
passiveReference: Character array which provides information about the passive reference dye used throughout the analysis. Only one dye can be chosen. Possible values are “FAM”, “VIC”, “JOE”, “NED”, “SYBR”, “TAMRA”, “TET” and “ROX”. The program doesn't support the use of other dyes.
directory: Character array which denotes the directory where the txt-file that shall be processed is saved. The correct path of the directory has to be given.

The program first checks the input parameters; in detail the following checks are done:
Is the input parameter “basename” a character array? If not, the output variable “expressionData” is set to [ ] and the error message
   “basename” has to be a string.
   is printed on the screen.
Is the input parameter “directory” a character array? If not, the output variable “expressionData” is set to [ ] and the error message
File <basename>: “directory” has to be a string.
   is printed on the screen.
Does the file “<basename>mc.txt” exist in the directory given by “directory”? If not, the message
   Input file “<basename>mc.txt” does not exist in the directory <directory>.
   is saved, but no error is reported so far.
Is the input parameter “reporter” a character array or a 1*n cell array of strings? If not, the message
File <basename>: “reporter” has to be a string or a cell array of strings.
   is saved, but no error is reported so far.
Is the input parameter “passiveReference” a character array? If not, the message
   File <basename>: “passiveReference” has to be a string.
   is saved, but no error is reported so far.
If up to now any messages are stored, “expressionData” is set to [ ] and these messages are thrown out as error on the screen.
Does any of the reporter dyes or the passive reference dye chosen deviate from the values which are allowed (see above)? If yes, “expressionData” is set to [ ] and the error message
   File <basename>: Possible dyes are FAM, VIC, JOE, NED, SYBR, TAMRA, TET and ROX.
is printed on the screen.

Afterwards, the first fields of the structure “expressionData” are set: “expressionData.source” is defined as “SDS” and “expressionData.wellNames” becomes a 16*24 cell array consisting of the entries “A1”, . . . , “P24”. In addition “expressionData.basename”, “expressionData.reporter” and “expressionData.passiveReference” are assigned the associated input parameters. When this is done the txt-file “<basename>mc.txt” is opened and the function goes through the lines of the file and does the following:
The first entry of the first line is saved as “expressionData.sdsVersion” and it is checked whether it equals “SDS 2.2”, “SDS 2.2.2” or “SDS 2.3”. If this is not fulfilled it is tested if the entry does not begin with “SDS” at all. In the case it does not begin with “SDS”, the message
   File <basename>: File format inconsistency.
Did you really export the multicomponent output?
   is saved, but no error is reported so far.

In the case it begins with “SDS”, the message
File <basename>: You chose the wrong version of the SDS software! Version 2.2 or 2.2.2 or 2.3 has to be used.
   is saved, but no error is reported so far.
The field “expressionData.wellsUsed” is set to a 16*24 logical array entirely consisting of “false” entries.

The following steps are repeated until the end of the txt-file:
It is checked if the first entry of the next line equals the word “Well”, in other words it is checked if the next line is the header line of an adjacent section of intensity data. If this is not the case the message
   File <basename>: File format inconsistency.
Did you really export the multicomponent output?
   is saved, but no error is reported so far.
If up to now any messages are stored, these messages are thrown out as error on the screen.
Those dyes which occur in the header line are stored in the field “expressionData.dyes. names”.
The following lines are skipped whenever the value of the column entitled “Step” does not equal “1”. In case it equals “1” a line is only skipped if already three different lines with the same values for “Well”, “Repeat” and “Step” exist. If a line does not have to be skipped, the values found in the columns entitled “Repeat” and “<dye>” are saved in the variables “expressionData.dyes.<dye>.cycle” and “expressionData.dyes.<dye>.intensity” respectively. Both of these fields are 16*24 cell arrays, each cell being a n*3 numeric array where n denotes the largest value occurring in the column entitled “Repeat” for the well currently in progress. If there are no intensity data for a well, the corresponding cells of “expressionData.dyes.<dye>.cycle” and “expressionData.dyes.<dye>.intensity” are empty.
Those lines following a section of intensity data are skipped until the next potential header line occurs.

When the end of the txt-file is reached some amendments have to be made:
For all dyes which are allowed, namely “FAM”, “VIC”, “JOE”, “NED”, “SYBR”, “TAMRA”, “TET” and “ROX”, it is checked if they occur in the field “expressionData.dyes”. This being the case for dye “<dye>”, a 16*24 logical array “expressionData.dyes.<dye>.wellsUsed”, entirely consisting of “false” entries, is defined. For those cells of “expressionData.dyes.<dye>.intensity” which are not empty the corresponding entries of “expressionData.dyes.<dye>.wellsUsed” and “expressionData.wellsUsed” are set to “true”.
Those dyes stored in “expressionData.reporter” are processed and for each of them a field “expressionData.dyes.<dye>.quencher” is initialised as 16*24 cell array. For each well, all dyes which were on the one hand used in the corresponding well and on the other hand are neither reporter dye nor passive reference dye are saved as corresponding entry of “expressionData.dyes.<dye>.quencher”. It has to be mentioned that in the case of more than one reporter dye the same quencher dyes are saved in “expressionData.dyes.<dye>.quencher” for all of them, because the multicomponent output of the SDS software provides no information about the togetherness of reporter dyes and quencher dyes. An important fact one has to keep in mind is that the use of the Black Hole Quencher produces no column of intensity data in the multicomponent output, this means the field “expressionData.dyes.<dye>.quencher” never contains an entry “BHQ”.

### 3.1.2. Using MX3005 and MX Pro Software

Data Export from MX Pro Software

The program described in the next section expects xls-files of a certain structure which have to be exported from the MX Pro software manually. Version 4.01 should be used, but since the version is not explicitly specified in the xls-file the use of the appropriate version can not be checked by the program which imports the data included in the xls-file to MATLAB. Therefore other versions are supported, too, but their use is not recommended. To export the data from the MX Pro software, one has to choose “Export Instrument Data/Export Instrument Data to Excel/Format 1—Columnar” in the menu “File”. The Excel file which pops up afterwards should be saved under the name of the corresponding MX Pro-file, but with extension “.xls” instead of “.mxp”. Afterwards the MX Pro software isn't needed anymore. The xls-file which is exported satisfies the following structure:
The first line is just a header for the different columns of the following lines, entitling them “Segment”, “Ramp/Plateau”, “Ramp/Plateau #”, “Well”, “Dye”, “Cycle #”, “Fluorescence” and “Temperature”.
The following lines contain information about the intensity measurements in the different wells and cycles. Since an MX3005 plate comprises 96 wells (contained in 8 rows and 12 columns), each qPCR run consists of 50 cycles and during each cycle only one measurement is done, normally 4800 lines per dye are generated. Similar to the SDS software, the wells in the first row are denoted “A1”, “A2” etc., the wells in the second row are denoted “B1”, “B2” etc. and so on. In the column entitled “Well” the wells are labeled by a number from “1” to “96”: well “A1” is assigned the “1”, well “A2” is assigned the “2” and so on. The headers “Dye”, “Cycle #” and “Fluorescence” are self-explanatory; the other columns contain supplementary information which is unnecessary to understand for the purposes of this documentation.

### 3.2. Fitting of Rₙ Curves and Computation of C_{q} Values

The program which fits the data and computes the C_{q} values is called “FitAndComputeBV”. It is called with two input parameters and two output parameters:

[fitData, msg]=FitAndComputeBV(expressionData, outputFunction).

The parameters “msg” and “outputFunction” are optional parameters which are only needed when the program is started from a GUI (graphical user interface). They won't be considered here. The input parameter “expressionData” is the MATLAB structure generated by the program “ImportSDSFileFromTXT” or “ImportMXProFileFromXLS”. The program first checks the validity of the input parameter “expressionData”. When using one of the programs described in the previous section to gain the variable “expressionData” some of the following errors can't occur, but they are described here nevertheless. In particular, the following steps are done:
Does “expressionData.source” equal “SDS” or “MX Pro”? If not, the message

File <basename>: Source <expressionData.source> unknown.
is prepared, but no error is reported so far. In the case “expressionData.source=SDS” the number of rows, columns and cycles is set to 16, 24 and 40 respectively, while in the case “expressionData.source=MX Pro” it is set to 8, 12 and 50 respectively.
Was at least one of the reporter dyes specified by the operator really measured during the qPCR reaction? In other words: Is any of the reporter dyes specified in “expressionData.reporter” contained in “expressionData.dyes.names”, too? If not, the message
   File <basename>: At least one reporter dye has to be measured.
   is prepared, but no error is reported so far.
Was the passive reference dye specified by the operator really measured during the qPCR reaction? In other words: Is “expressionData.passiveReference” contained in “expressionData.dyes.names”? If not, the message

File <basename>: Passive reference has to be measured.
is prepared, but no error is reported so far.
If up to now any messages are stored, “fitData” is set to [ ] and these messages are thrown out as error on the screen.

The program loops over all reporter dyes specified in “expressionData.reporter” and does the following:
Double arrays “fitData.<dye>.firstCycleUsed”, “fitData.<dye>.y0”, “fitData.<dye>.r”, “fitData.<dye>.a”, “fitData.<dye>.b”, “fitData.<dye>.n0”, “fitData.<dye>.converged”, “fitData.<dye>.mse”, “fitData.<dye>.absNorm” and “fitData.<dye>.rule” of the size “number of rows”*“number of columns” and a (“number of rows”*“number of columns”) cell array “fitData.<dye>.cq” are initialised, all except the last consisting of NaNs only.
   The next steps are performed for each well:
It is checked if “expressionData.wellsUsed” is “true” for the current well. If not, the message
   File <basename>: Well(s) not used: <well>.
is prepared, but no warning is printed on the screen yet. If the well is not used for more than one well, the message is expanded to
File <basename>: Well(s) not used: <well 1>, <well 2>.
   and so on.
For the current well, it is checked if “expressionData.dyes.<expressionData. passiveReference>.wellsUsed” is “true”. This not being true, the message
   File <basename>: Passive reference
   <expressionData.passiveReference> not used in well(s): <well>.
is prepared, but no warning is printed on the screen yet. If the passive reference is not used in more than one well, the message is expanded to
   File <basename>: Passive reference <expressionData.passiveReference> not used in well(s): <well 1>, <well 2>.
   and so on.
It is checked if “expressionData.dyes.<dye>.wellsUsed” is “true” for the current well. If not, the message
   File <basename>: Reporter dye <dye> not used in well(s): <well>.
   is prepared, but no warning is printed on the screen yet. If the reporter is not used in more than one well, the message is expanded to
   File <basename>: Reporter dye <dye> not used in well(s): <well 1>, <well 2>.
   and so on.
If either the whole current well or the passive reference dye or the current reporter dye was not used, the corresponding entry of “fitData.<dye>.cq” is set to “#NV” and the next well is investigated. Setting the C_{q} value to “#NV” is an abbreviation of calling it “Missing”.
It is checked if “expressionData.dyes.<expressionData.passiveReference>.cycle” equals the default cycle layout. This cycle layout depends on “expressionData. source”. In the case “SDS” it is a 40*3 array, each row consisting of three identical integers, the first row being [1 1 1], the second row being [2 2 2] and so on. When using the MX Pro software, the default cycle layout is a 50*1 array consisting of integers from 1 to 50 in ascending order. If “expressionData.dyes.<expressionData. passiveReference>.cycle” differs from the default or any of the values stored in “expressionData.dyes.<expressionData.passiveReference>.intensity” equals NaN, the message
File <basename>: Invalid repeat (cycle) layout for dye <expressionData.passiveReference> in well(s): <well>.
is prepared, but no warning is printed on the screen yet. The corresponding entry of “fitData.<dye>.cq” is set to “#NV” and the next well is investigated. If the cycle layout of the passive reference dye differs from the default or any of the values stored in “expressionData.dyes.<expressionData.passiveReference>.intensity” equals NaN in more than one well or the, the message is expanded to
File <basename>: Invalid repeat (cycle) layout for dye <expressionData.passiveReference> in well(s): <well 1>, <well 2>.
   and so on.
It is checked if “expressionData.dyes.<dye>.cycle” equals the default cycle layout. This not being the case, the message
File <basename>: Invalid repeat (cycle) layout for dye <dye> in well(s): <well>.
is prepared, but no warning is printed on the screen yet. It is saved, too, when any of the values stored in “expressionData.dyes.<dye>.intensity” equals NaN. The corresponding entry of “fitData.<dye>.cq” is set to “#NV” and the next well is investigated. If the cycle layout of the current reporter dye differs from the default or any of the values stored in “expressionData.dyes.<dye>.intensity” equals NaN in more than one well, the message is expanded to
File <basename>: Invalid repeat (cycle) layout for dye <dye> in well(s): <well 1>, <well 2>.
   and so on.
The variable “firstCycle” is set to three, meaning that the first two cycles of the qPCR reaction will not be considered during the following fitting procedure. As will be described below there is the possibility to increase “firstCycle” iteratively if this is necessary.
The fluorescence data of the reporter dye are normalised by the fluorescence data of the passive reference dye, the resulting variable is called “Rn”. Depending on “expressionData.source”—“SDS” or “MX Pro”—it is a 40*3 or 50*1 double array, respectively. The first up to the (“firstCycle”−1)^{th} row of “Rn” is deleted.
Provided that one cycle consists of three repeats and 40 cycles were measured (which is the case when the SDS software was used), the next step is to eliminate possible outliers. This procedure is described in detail in chapter 3. Those entries which are outliers are set to NaN; cycles which consist of only one non-NaN entry (regardless of whether the other two entries were NaN from the beginning or were characterized as outliers) are set to [NaN NaN NaN] to completely exclude them from the fitting procedure. After having eliminated all outliers, the mean of the non-NaN repeats of each cycle is computed. If all repeats are NaN, the mean is set to NaN, too. What results is a (40−“firstCycle”+1)*1 double array consisting of one normalized fluorescence value for each cycle of the qPCR reaction in the current well. This array is called “Rn” again.
The variable “regressionRange” is set to a (“number of cycles”−“firstCycle”+1*1) double array consisting of integers ranging from “firstCycle” to “number of cycles” in ascending order.
Those values of “Rn” which are NaN and the corresponding entries of “regressionRange” are deleted temporarily.
The MATLAB function “fmincon” is used to fit the data to the Gompertz model which is described in detail in chapter 3. The purpose of “fmincon” is to find a local minimum of a constrained nonlinear multivariable function. We use it in the form

[x, fval, exitflag]=fmincon(fun, x_{—}0, . . . [ ], [ ], [ ], [ ], [ ], [ ], nonlcon, options).
with the following input parameters:
   fun: Handle to the function that has to be minimized. “fun” has to be a function that returns a scalar value when being evaluated at x. It is called “objective function”.
   x_{—}0: Scalar, vector or matrix that specifies the starting value for “fmincon”, that means the value “fun” should be evaluated at right at the beginning. In case there are many local minima “x_{—}0” should be close to the minimum that shall be found.
   nonlcon: Handle to a function implementing nonlinear constraint(s). In our case “nonlcon” is a function which evaluates one nonlinear constraint “c” at “x” and returns a scalar, meaning that the minimum of “fun” has to be found under the constraint

c(x)≦0 (58)
options: Structure that contains further information about some optimization parameters.
The output parameter “x” is the value that minimizes “fun” under the given constraints, “fval” is the result when evaluating “fun” at “x” and “exitflag” contains information about the performance of the fit.
Since the objective function (Gompertz fit with regularization) and the constraint (non-linearity constraint) require similar calculations (see below) we coded both in a common local function “loc_Gompertz”:

fun=@(x)loc_Gompertz(x, regressionRange, Rn, ‘objective’)

nonlcon=@(x)loc_Gompertz(x, regressionRange, Rn, ‘constraint’)
As described in chapter 3, the parameters y₀, r, and a are computed analytically for given β and n₀, therefore the variable “x” and the starting value “x_{—}0” are two-dimensional arrays, the first entry containing information about β, the second entry belonging to n₀. An appropriate starting value for n₀ is found by computing the differences of subsequent values of “Rn” and searching for the cycle for which this difference is maximal. The maximum of this number and 30 is used as starting value for n₀. The starting value for β is −log(0.3). The fitting options have to be set carefully to assure that on the one hand the fit is successful for all curves and that it does not take too much time on the other hand. They are chosen as follows:
   “TypicalX”=[1, 10]: Provides information about the typical magnitude of the result of the minimization. β is assumed to be ˜1, n₀ is assumed to be ˜10.
   “RelLineSrchBnd”=0.1: Specifies a relative bound on the length a step in the search algorithm may have. If “RelLineSrchBnd” is too high, the possibility of tunnelling from one valley to another and therefore finding the wrong local minimum is given.
   “RelLineSrchBndDuration”=Inf: Sets the number of iterations during the search algorithm for which the bound defined in “RelLineSrchBnd” shall be active.
   “LargeScale”=“off”: Provides information about the type of search algorithm that should be used, in this case a medium-scale algorithm is chosen.
   “TolFun”=10⁻⁴: Specifies a lower bound for the change of the value of the objective function during the search algorithm, in other words: Whenever an evaluation of the objective function results in a value that differs less than “TolFun” from the value of the former evaluation the optimization ends.
   “TolX”=10⁻⁴: Specifies a lower bound for the step size during the search algorithm, this means: Whenever a step is smaller than “TolX” the optimization ends.
What remains to be described is on the one hand the objective function and on the other hand the nonlinear inequality constraint. Both of them are closely related and rely on a function called “loc_Gompertz” whose call is of the general form

[result, dummy]=loc_Gompertz(x, data_{—}x, data_{—}y, resultType).
As can be seen above, objective function as well as constraint function are called with an anonymous parameter “x” and “data_x” and “data_y” are given by “regressionRange” and “Rn” respectively. The parameter “resultType” has to be chosen as ‘objective’ when the objective function shall be evaluated and as ‘constraint’ when the nonlinear inequality constraint shall be computed. Given values for β and n₀ (via “x”) it is first checked if these values are finite. This not being the case, an error message of the form
   loc_Gompertz: Parameters have to be finite.
is prepared, but not printed on the screen. Both parameters being finite, the remaining parameters y₀, r, and a are determined by equation (38) using the variables and constants specified in chapter 3. One has to notice that the computation of the inverse matrix should be done by the MATLAB function “pinv” which computes the Moore-Penrose pseudoinverse instead of the real inverse in case the matrix is not singular. Knowing all five parameters which characterize a Gompertz function one is now able to calculate “result” via equations (19) and (39). If “resultType” equals ‘constraint’, the nonlinear inequality constraint shall be computed; for this purpose the linearityNorm given by equation (25) has to be determined and subtracted from 10⁻³. The result of this operation is stored in the output parameter “result”, too. By specifying this constraint all choices of parameters which result in a linearityNorm that is smaller than 10⁻³ are forbidden. Because a linear equality constraint (which is not needed here) has to be specified, too, a parameter “dummy” is created and set to [ ].
Whenever an error occurs in the call of the function “loc_Gompertz” it is checked if this error is caused by one of the parameters β or n₀ being not finite. If none of them is infinite, the function “FitAndComputeBV” is terminated and an error message is written in the MATLAB command window. If at least one of the parameters is infinite, we suggest an internal problem within the function “fmincon” and “fmincon” is called again with a slightly changed starting value “x_{—}0”. More precisely, the former starting value for beta is multiplied with 1.0001 while the starting value for n₀ remains constant. If β or n₀ is still infinite after ten iterations, the parameters y₀, r, a, β, n₀, “is_converged”, mse, and linearityNorm are set to NaN and the temporary message
   an error occurred when trying to fit the data.
is prepared. If the problem can be fixed by changing the starting value, the temporary message
   starting value for beta had to be changed to <value>.
is prepared and the mean squared error of the Gompertz regression is calculated according to equations (19) and (26). In the case no error occurs in “loc_Gompertz” only the mean squared error of the regression is calculated.
It is checked if the temporary message
   an error occurred when trying to fit the data.
was prepared during the Gompertz regression. This being true, the message
   File <basename>, well <well>: an error occurred when trying to fit the data.
is prepared, but no warning is printed on the screen yet. The appropriate entries of fitData.<dye>.cq and fitData.<dye>.rule are set to “x” and “1” respectively and the next well is investigated. Setting the C_{q} value to “x” is an abbreviation of calling it “Invalid”. If this situation occurs for more than one well, the message is expanded to
   File <basename>, well <well 1>: an error occurred when trying to fit the data.
   File <basename>, well <well 2>: an error occurred when trying to fit the data.
and so on.
It is checked if a temporary message of the form
   starting value for beta had to be changed to <value>.
was prepared during the Gompertz regression. This being the case, the message
File <basename>, well <well>, first cycle used <firstCycle>: starting value for beta had to be changed to <value>.
is prepared, but no warning is printed on the screen yet. If this situation occurs for more than one well or more than one iteration of the same well, the message is expanded to
File <basename>, well <well 1>, first cycle used <firstCycle 1>: starting value for beta had to be changed to <value 1>.
File <basename>, well <well 2>, first cycle used <firstCycle 2>: starting value for beta had to be changed to <value 2>.
and so on.
It is checked if the first cycle used in the Gompertz regression—given by “firstCycle”—is an outlier compared to the rest of the model. For this purpose the absolute difference between the first value of “Rn”, “Rn(1)”, and the value of the Gompertz model in the first cycle used is compared to the root mean squared error of the whole model (sqrt(mse)). Whenever the absolute difference does not exceed the threefold root mean squared error the cycle given by “firstCycle” is not considered an outlier. If this condition is not fulfilled or the logarithmized mean squared error is greater than or equal to −4 the validity of the Gompertz regression is doubted. In this case “firstCycle” is increased by one and the whole fitting procedure (beginning with the definition of the variable “Rn”) is repeated.
There are two possibilities to stop this iteration. On the one hand the Gompertz regression can be valid (this is the case if the first cycle used is no outlier and the mean squared error of the whole model is small enough), on the other hand an interruption can be forced by the program because the variable “firstCycle” exceeds the total number of cycles (40 if the SDS software is used, 50 in the case “expressionData.source=MX Pro”). In the latter case, the variable “firstCycle” and the parameters y₀, r, a, β, n₀, “is_converged”, mse, and linearityNorm are set to NaN. In the former case, all parameters can be used in the form they were gained from the Gompertz regression.
The next step is to check if the normalized fluorescence of any of the cycles used has to be doubted. This is the case if either all repeats (three in the case “expressionData.source=SDS”, one in the case “expressionData.source=MX Pro”) were NaN from the beginning or outliers were found that resulted in an “Rn” value of [NaN NaN NaN]. If any of the cycles has to be doubted the message
   File <basename>: Whole cycle is an outlier for dye <dye> in well(s): <well>.
is prepared, but no warning is printed on the screen yet. The appropriate entries of “expressionData.<dye>.cq” and “expressionData.dye.rule” are set to “x” and “2” respectively and the next well is investigated. If the normalised fluorescence of any of the cycles used has to be doubted for more than one well, the message is expanded to
   File <basename>: Whole cycle is an outlier for dye <dye> in well(s): <well 1>, <well 2>.
and so on.
If the parameter is_converged is less than or equal to zero—indicating that the fitting procedure couldn't find an optimum—the message
   File <basename>: No convergence for dye <dye> in well(s): <well>.
is prepared, but no warning is printed on the screen so far. If the convergence problem occurs for more than one well, the message is expanded to
   File <basename>: No convergence for dye <dye> in well(s): <well 1>, <well 2>.
and so on.
The parameters n₀, r, a, exp(β), n₀, “is_converged”, mse, and linearityNorm are saved in the suitable positions of “fitData.<dye>.y0”, “fitData.<dye>.r”, “fitData.<dye>.a”, “fitData.<dye>.b”, “fitData.<dye>.n0”, “fitData.<dye>.converged”, “fitData.<dye>.mse” and “fitData.<dye>.linearityNorm”.
The AIP value is computed via equation (45) and saved in a variable called “cq”. Another variable called “rule” is set to NaN.
The next step is to determine if any of the rules is fulfilled and change “cq” and “rule” suitably:
   Is “firstCycle” greater than or equal to ten or even NaN? If yes, “cq” is set to “x” and “rule” is changed to “3”.
   Does the absolute value of y₀ exceed 20? If yes, “cq” is altered to “x” and “rule” becomes “4”
   Does the absolute value of r exceed one? If yes, “cq” is altered to “x” and “rule” becomes “5”
   Is a greater than 25 or smaller than −15? If yes, “cq” is set to “x” and “rule” is changed to “6”.
   Does exp(β) exceed 50? If yes, “cq” is altered to “x” and “rule” becomes “7”.
   Is n₀ greater than 65 or smaller than 15? If yes, “cq” is set to “x” and “rule” is changed to “8”.
   Is the logarithmized linearityNorm smaller than or equal to −3.5? If yes, “cq” is set to “Undetected” and “rule” is changed to “9”.
   Is the logarithmized linearityNorm smaller than or equal to −1.5 and β greater than or equal to 2.2? If yes, “cq” is set to “Undetected” and “rule” is changed to “10”.
   Is “cq” smaller than 34 and a smaller than or equal to 0.2? If yes, “cq” is called “Undetected” and “rule” becomes “11”.
   Is “cq” smaller than 34 and a greater than 0.2 as well as smaller than 1? If yes, “cq” is altered to “x” and “rule” is changed to “12”.
   Is “cq” greater than or equal to 34 and a smaller than or equal to 0.6? If yes, “cq” is set to “Undetected” and “rule” becomes “13”.
   Is “cq” greater than or equal to 40? If yes, “cq” is called “Undetected” and “rule” is changed to “14”.
The values for “cq” and “rule” are saved as entries of “fitData.<dye>.cq” and “fitData.<dye>.rule” in the appropriate positions.

After all these steps are done for all wells and all reporter dyes, all warning messages that were saved during the fitting process are printed as warnings on the screen.

1. Method for determining the concentration or activity of an analyte in a sample, the method comprising:
a) mixing a sample with at least one reagent, whereby an analyte-dependent amplification reaction is set in motion, wherein the amplification of the analyte is detectable by a signal;
b) measuring a signal changing over time as a result of the analyte-dependent amplification reaction;
c) mathematically fitting a curve to signal measurements, wherein said mathematical fitting comprises of
(i) the use of an extended Gompertz function, given by:
$${f}_{gompertz} ( x ) = {y}_{0} + r \cdot x + a \cdot exp ( - exp ( - \frac{x - {n}_{0}}{b} ) ) ,$$
where x denotes the time, f denotes the signal, and y0, r, a, n0 and b are parameters to be fitted,
(ii) regularization of at least one parameter or a mathematical combination of parameters such that signal curves not showing saturation within the observed time interval can be fitted robustly and with sufficient confidence,
(iii) and mathematically extracting a score value from said fitted curve;
d) performing a quality control of said signal-time curve and determining the concentration or activity of said analyte, comprising the steps of
1) Determination if said signal-time curve is valid, wherein said signal-time curve is valid, if said score value can be extracted reliably,
2) Determination if the initial number of template molecules is below a limit of detection (LOD), and
3) Determination of the concentration, wherein the score value relates to the initial number of analyte molecules for all curves which are valid,
wherein steps (1), (2), and (3) can be performed in any given order.

2. Method according to claim 1, wherein the analyte is a nucleic acid, in particular DNA or RNA, in particular mRNA.

3. Method according to claim 1, wherein the analyte-dependent amplification reaction is a PCR reaction, in particular a Reverse Transcriptase PCR (RT-PCR) reaction.

4. Method according to claim 1, wherein the amplification of the analyte is detectable by a fluorescence or optical signal.

5. Method according to claim 1, wherein an absolute concentration can be determined by use of an internal standard of known concentration.

6. Method according to claim 1, wherein said regularization is performed on parameter a.

7. Method according to claim 6, wherein said regularization is realized by a summand additional to the objective function used for fitting, where the summand is a weighted square of the z-transformed parameter a. Parameters of the z-transformation, i.e. mean and standard deviation, are empirical estimates from samples of signal curves showing saturation within the observed time interval which were known to be fitted robustly and with sufficient confidence.

8. Method according to claim 1, wherein parameters are constrained during fitting to ensure robust and confident estimation of parameters for curves showing no amplification behavior or amplification behavior in the very end only. Constraints may be uni- or multivariate, linear or non-linear.

9. Method according to claim 8, wherein a constraint is used comprising the following steps (linearityNorm):
(i) A linear model is fitted to the extended Gompertz model on the observed time interval. (Said extended Gompertz model is defined by some parameter set which may not be optimal.)
(ii) The deviation between the linear and the extended Gompertz model is calculated using some mathematical norm (e.g. Euclidian, Manhattan or max-Norm) and based on the observed time interval.
(iii) Said deviation is compared to a suitable threshold such that a parameter set of the extended Gompertz model is said to be allowed if said deviation is above said threshold and the parameter set is said to be forbidden if said deviation is below said threshold.
Alternatively, instead of the extended Gompertz model one can use the Gompertz core only, which is defined as
$${f}_{gompertzCore} ( x ) = exp ( - exp ( - \frac{x - {n}_{0}}{b} ) ) .$$

10. Method according to claim 1, wherein the fitting of the extended Gompertz model is realized by a gradient-based or local optimization algorithm and wherein the starting point for said optimization algorithm and its configuration is chosen such that the resulting local optimum corresponds to a fitted model, for which the technical interpretation of the curve corresponds to the meaning of the parameters: parameters y0 and r describe the beginning of the curve (background), parameters n0 and b describe the time point and velocity—respectively—of the amplification growth, and parameter a describes the height of the saturation level above background. In particular, parameters b and a must be positive.

11. Method according to claim 10, wherein the model fit is realized using a Euclidean distance measure, and wherein the optimization is nested by separating parameters: For fixed parameters b and n0 parameters y0, r, and a are optimized analytically by linear algebra operations since the objective function (including regularization) is a quadratic form of these parameters; and parameters b and n0 are optimized non-linearly in an outer loop. This approach is advantageous, because it needs fewer iterations, it is more robust, and starting values have to be defined only for parameters b and n0.

12. Method according to claim 1, wherein said quality control classification is realized by a decision tree, wherein each decision is based on at least one feature from the following list: said parameters (y0, r, a, b, n0), said score, a goodness-of-fit measure, the times of observation (in particular the bound of the interval) and features from constraints according to claims 8 or 9 if used. Each decision is derived from empirical training data by a data-driven method, wherein training curves are classified into said quality control classes by manual inspection, commercially available software or a combination of both.

13. Method according to claim 12, wherein said observed time interval may be restricted previous to described calculations in order to eliminate measurement outliers or parts of the curve showing behavior deviating from typical amplification behavior.

14. Method according to claim 13, wherein said decision tree is degenerated to the following linear list of rules:
Is firstCycle greater than or equal to 10? If yes, set classification to “Invalid”.
Does the absolute value of y0 exceed 20? If yes, set classification to “Invalid”.
Does the absolute value of r exceed 1? If yes, set classification to “Invalid”.
Is a greater than 25 or smaller than −15? If yes, set classification to “Invalid”.
Does b exceed 50? If yes, set classification to “Invalid”.
Is n0 greater than 65 or smaller than 15? If yes, set classification to “Invalid”.
Is the logarithm of linearityNorm smaller than or equal to −3.5? If yes, set classification to “Undetected”.
Is the logarithm of linearityNorm smaller than or equal to −1.5 and the logarithm of b greater than or equal to 2.2? If yes, set classification to “Undetected”.
Is score smaller than 34 and a smaller than or equal to 0.2? If yes, set classification to “Undetected”.
Is score smaller than 34 and a greater than 0.2 as well as smaller than 1? If yes, set classification to “Invalid”.
Is score greater than or equal to 34 and a smaller than or equal to 0.6? If yes, set classification to “Undetected”.
Is score greater than or equal to 40? If yes, set classification to “Undetected”.
Otherwise set classification to “Valid”.
where
measurements have been undertaken at times x=1, 2, 3, 4, . . . (cycle numbers).
firstCycle is related to the number of the first cycle where the measured signal is not an outlier with respect to the fitted model.
linearityNorm is a measure of the linearity of the fitted model according to claim 9 using the max-Norm and the Gompertz core. The linearityNorm constraint is defined by comparing the logarithm of the linearityNorm with a threshold
the score is calculated as: score=n0−0.72b.

15. Apparatus which is capable of automatically carrying out the method according to claim 1 for determining the activity or concentration of an analyte, comprising
a) means for the determination of the signal changing over time as a result of the analyte-dependent amplification reaction,
b) means for mathematically fitting a curve to signal measurements and mathematically extracting a score value from said fitted curve and storing a resultant score value, wherein said mathematical fitting comprises the use of a Gompertz function,
c) means for performing a quality control of said signal-time curve, and
d) means for determining a concentration or activity of the analyte according to said score value.

16. Computer program product including computer-usable program code executable by a processor to perform method a method of:
i) mathematically fitting a curve to signal measurements and mathematically extracting a score value from said fitted curve and storing a resultant score value, wherein said mathematical fitting comprises the use of a Gompertz function,
ii) performing a quality control of said signal-time curve, and
iii) determining a concentration or activity of the analyte according to said score value.
